(19) United States
(12) Patent Application Publication
(10) Pub. No.: US 2023/0291263 A1
(43) Pub. Date: Sep. 14, 2023

(54) STATOR, ELECTRIC MOTOR, COMPRESSOR, AIR CONDITIONER, AND METHOD FOR FABRICATING STATOR

(71) Applicant: Mitsubishi Electric Corporation, Tokyo (JP)

(72) Inventor: Atsushi MATSUOKA, Tokyo (JP)

(21) Appl. No.: 18/002,504

(22) PCT Filed: Sep. 2, 2020
(86) PCT No.: PCT/JP2020/033180

§ 371 Date: Dec. 20, 2022

(51) Int. Cl. H02K 3/28; F25B 31/02; H02K 21/14; H02K 15/085

(52) U.S. Cl. CPC H02K 3/28; F25B 31/026; H02K 21/14; H02K 15/085

(57) ABSTRACT

A stator includes a stator core and three-phase coils attached to the stator core by distributed winding. The three-phase coils include 6×n U-phase coils, 6×n V-phase coils, and 6×n W-phase coils in a coil end. The 6×n U-phase coils, the 6×n V-phase coils, and the 6×n W-phase coils each include 2×n sets of coil groups each including a set of first to third coils. Each of the first to third coils is disposed in the stator core at two-slot pitch. A part of the third coil is disposed in the slot in which a part of the second coil is disposed.

### CROSS-REFERENCE TO RELATED APPLICATION

This application is a U.S. National Stage Application of International Application No. PCT/JP2020/033180 filed on Sep. 2, 2020, the contents of which are incorporated herein by reference.

### TECHNICAL FIELD

The present disclosure relates to a stator for an electric motor.

### BACKGROUND

A stator including three-phase coils is generally known (see, for example, Patent Reference 1). A stator core disclosed in Patent Reference 1 includes 24 slots, the three-phase coils form eight magnetic poles, and the number of slots to one magnetic pole is three. In this stator, coils of each phase are disposed for each three slots and attached to the stator core by lap winding. Two coils of the same phase are disposed in each slot. In this case, the stator has the advantage of utilizing 100% of magnetic flux from the rotor toward the stator.

### PATENT REFERENCE

Patent Reference 1: Japanese Unexamined Utility Model Registration Application Publication No. S53-114012

The electric motor utilizing 100% of magnetic flux from the rotor toward the stator, however, is significantly affected by a harmonic component included in magnetic flux from the stator, and thus, an induced voltage including a large amount of harmonics is generated in coils of each phase. Consequently, vibrations in the electric motor increase.

### SUMMARY

It is therefore an object of the present disclosure to reduce vibrations in an electric motor.

A stator according to an aspect of the present disclosure includes: a stator core; and three-phase coils attached to the stator core by distributed winding, wherein the stator core includes 24×n (n is an integer equal to or larger than 1) slots, the three-phase coils include 6×n U-phase coils, 6×n V-phase coils, and 6×n W-phase coils in a coil end of the three-phase coils and form 10×n magnetic poles, the 6×n U-phase coils, the 6×n V-phase coils, and the 6×n W-phase coils each include 2×n sets of coil groups, the 2×n sets of coil groups each including a set of first to third coils, the first to third coils are arranged in that order in a circumferential direction in the coil end, the first coil is disposed in the stator core at two-slot pitch, the second coil is disposed in the stator core at two-slot pitch, the third coil is connected in series to the second coil and is disposed in the stator core at two-slot pitch, and a part of the third coil is disposed in the slot in which a part of the second coil is disposed.

A stator according to another aspect of the present disclosure includes: a stator core; and three-phase coils attached to the stator core by distributed winding, wherein the stator core includes 24×n (n is an integer equal to or larger than 1) slots, the three-phase coils include 8×n U-phase coils, 8×n V-phase coils, and 8×n W-phase coils in a coil end of the three-phase coils and form 10×n magnetic poles, the 8×n U-phase coils, the 8×n V-phase coils, and the 8×n W-phase coils each include 2×n sets of coil groups, the 2×n sets of coil groups each including a set of first to fourth coils, the second coil is disposed inward from the first coil in the coil end, the second to fourth coils are arranged in that order in a circumferential direction, the first coil is disposed in the stator core at two-slot pitch, the second coil is disposed at two-slot pitch in the slot in which the first coil is disposed, the third coil is disposed in the stator core at two-slot pitch, the fourth coil is connected in series to the third coil and is disposed in the stator core at two-slot pitch, a part of the fourth coil is disposed in the slot in which a part of the third coil is disposed, and the first coil and the second coil are disposed with a coil of another phase sandwiched therebetween in the coil end.

An electric motor according to another aspect of the present disclosure includes: the stator; and a rotor disposed inside the stator.

A compressor according to another aspect of the present disclosure includes: a closed container; a compression device disposed in the closed container; and the electric motor to drive the compression device.

An air conditioner according to another aspect of the present disclosure includes: the compressor; and a heat exchanger.

A method for fabricating a stator according to another aspect of the present disclosure is a method for fabricating a stator including a stator core and three-phase coils attached to the stator core by distributed winding, the stator core includes 24×n (n is an integer equal to or larger than 1) slots, the three-phase coils include 6×n U-phase coils, 6×n V-phase coils, and 6×n W-phase coils in a coil end of the three-phase coils and form 10×n magnetic poles, the 6×n U-phase coils, the 6×n V-phase coils, and the 6×n W-phase coils each include 2×n sets of coil groups, the 2×n sets of coil groups each include a set of first to third coils, the first to third coils are arranged in that order in a circumferential direction in the coil end, and the method includes: disposing the first coil in the stator core at two-slot pitch; disposing the third coil in the stator core at two-slot pitch; and disposing the second coil in the stator core at two-slot pitch such that a part of the third coil and a part of the second coil are disposed in an identical slot.

A method for fabricating a stator according to another aspect of the present disclosure is a method for fabricating a stator including a stator core and three-phase coils attached to the stator core by distributed winding, the stator core includes 24×n (n is an integer equal to or larger than 1) slots, the three-phase coils include 8×n U-phase coils, 8×n V-phase coils, and 8×n W-phase coils in a coil end of the three-phase coils and form 10×n magnetic poles, the 8×n U-phase coils, the 8×n V-phase coils, and the 8×n W-phase coils each include 2×n sets of coil groups, the 2×n sets of coil groups each include a set of first to fourth coils, the second coil is disposed inward from the first coil in the coil end, the second to fourth coils are arranged in that order in a circumferential direction, and the method includes: disposing the first coil in the stator core at two-slot pitch; disposing the fourth coil in the stator core at two-slot pitch such that a part of the fourth coil and a part of the third coil are disposed in an identical slot; disposing the third coil in the stator core at two-slot pitch; and disposing the second coil at two-slot pitch in the slot where the first coil is disposed such that the first coil and the second coil are disposed with a coil of another phase sandwiched therebetween in the coil end.

According to the present disclosure, vibrations in an electric motor can be reduced.

### BRIEF DESCRIPTION OF THE DRAWINGS

FIG. 1 is a plan view schematically illustrating a structure of an electric motor according to a first embodiment.

FIG. 2 is a cross-sectional view schematically illustrating a structure of a rotor.

FIG. 3 is a plan view schematically illustrating a structure of a stator.

FIG. 4 is a diagram schematically illustrating arrangement of three-phase coils in a coil end and arrangement of three-phase coils in slots.

FIG. 5 is a diagram schematically illustrating a structure of the stator seen from the center of the stator.

FIG. 6 is a diagram schematically illustrating the structure of the stator seen from the outside of the stator.

FIG. 7 is a flowchart showing an example of a process of fabricating the stator according to the first embodiment.

FIG. 8 is a diagram illustrating an example of an inserter for inserting three-phase coils in a stator core.

FIG. 9 is a diagram illustrating an insertion step of first coils in step S11.

FIG. 10 is a diagram illustrating an insertion step of third coils in step S12.

FIG. 11 is a diagram illustrating an insertion step of second coils in step S14.

FIG. 12 is a table showing a comparison of winding factors.

FIG. 13 is a diagram illustrating another example of the stator core in the first embodiment.

FIG. 14 is a plan view schematically illustrating a structure of an electric motor according to a second embodiment.

FIG. 15 is a plan view schematically illustrating a structure of a stator according to the second embodiment.

FIG. 16 is a diagram schematically illustrating arrangement of three-phase coils in a coil end and slots.

FIG. 17 is a diagram schematically illustrating a structure of the stator illustrated in FIG. 15 seen from the center of the stator.

FIG. 18 is a diagram schematically illustrating a structure of the stator illustrated in FIG. 15 seen from the outside of the stator.

FIG. 19 is a flowchart showing an example of a process of fabricating the stator according to the second embodiment.

FIG. 20 is a diagram illustrating an insertion step of third coils in step S21.

FIG. 21 is a diagram illustrating an insertion step of second coils in step S23.

FIG. 22 is a diagram illustrating an insertion step of first coils in step S24.

FIG. 23 is a plan view schematically illustrating a structure of an electric motor according to a third embodiment.

FIG. 24 is a plan view schematically illustrating a structure of a stator according to the third embodiment.

FIG. 25 is a diagram schematically illustrating arrangement of three-phase coils in a coil end and slots.

FIG. 26 is a diagram schematically illustrating a structure of the stator illustrated in FIG. 23 seen from the center of the stator.

FIG. 27 is a diagram schematically illustrating a structure of the stator illustrated in FIG. 23 seen from the outside of the stator.

FIG. 28 is a flowchart showing an example of a process of fabricating the stator according to the third embodiment.

FIG. 29 is a diagram illustrating an insertion step of third coils in step S31.

FIG. 30 is a diagram illustrating an insertion step of first coils in step S33.

FIG. 31 is a diagram illustrating an insertion step of second coils in step S34.

FIG. 32 is a plan view schematically illustrating a structure of an electric motor according to a fourth embodiment.

FIG. 33 is a plan view schematically illustrating a structure of a stator according to the fourth embodiment.

FIG. 34 is a flowchart showing an example of a process of fabricating the stator according to the fourth embodiment.

FIG. 35 is a diagram illustrating an insertion step of first coils in step S41.

FIG. 36 is a diagram illustrating an insertion step of fourth coils in step S42.

FIG. 37 is a diagram illustrating an insertion step of third coils in step S44.

FIG. 38 is a diagram illustrating an insertion step of second coils in step S45.

FIG. 39 is a plan view schematically illustrating a structure of an electric motor according to a fifth embodiment.

FIG. 40 is a plan view schematically illustrating a structure of a stator according to the fifth embodiment.

FIG. 41 is a flowchart showing an example of a process of fabricating the stator according to the fifth embodiment.

FIG. 42 is a diagram illustrating an insertion step of first coils in step S51.

FIG. 43 is a diagram illustrating an insertion step of fourth coils in step S52.

FIG. 44 is a diagram illustrating an insertion step of second coils in step S54.

FIG. 45 is a diagram illustrating an insertion step of third coils in step S55.

FIG. 46 is a plan view schematically illustrating a structure of an electric motor according to a sixth embodiment.

FIG. 47 is a plan view schematically illustrating a structure of a stator according to the sixth embodiment.

FIG. 48 is a flowchart showing an example of a process of fabricating the stator according to the sixth embodiment.

FIG. 49 is a diagram illustrating an insertion step of fourth coils in step S61.

FIG. 50 is a diagram illustrating an insertion step of first coils in step S63.

FIG. 51 is a diagram illustrating an insertion step of third coils in step S64.

FIG. 52 is a diagram illustrating an insertion step of second coils in step S65.

FIG. 53 is a cross-sectional view schematically illustrating a structure of a compressor according to a seventh embodiment.

FIG. 54 is a diagram schematically illustrating a configuration of a refrigeration air conditioning apparatus according to an eighth embodiment.

### DETAILED DESCRIPTION

### First Embodiment

In an xyz orthogonal coordinate system shown in each drawing, a z-axis direction (z axis) represents a direction parallel to an axis Ax of an electric motor 1, an x-axis direction (x axis) represents a direction orthogonal to the z-axis direction, and a y-axis direction (y axis) represents a direction orthogonal to both the z-axis direction and the x-axis direction. The axis Ax is a center of a stator 3, and is a rotation center of a rotor 2. A direction parallel to the axis Ax is also referred to as an “axial direction of the rotor 2” or simply as an “axial direction.” The radial direction refers to a radial direction of the rotor 2 or the stator 3, and is a direction orthogonal to the axis Ax. An xy plane is a plane orthogonal to the axial direction. An arrow Dl represents a circumferential direction about the axis Ax. The circumferential direction of the rotor 2 or the stator 3 will be also referred to simply as a “circumferential direction.”

### <Electric Motor 1>

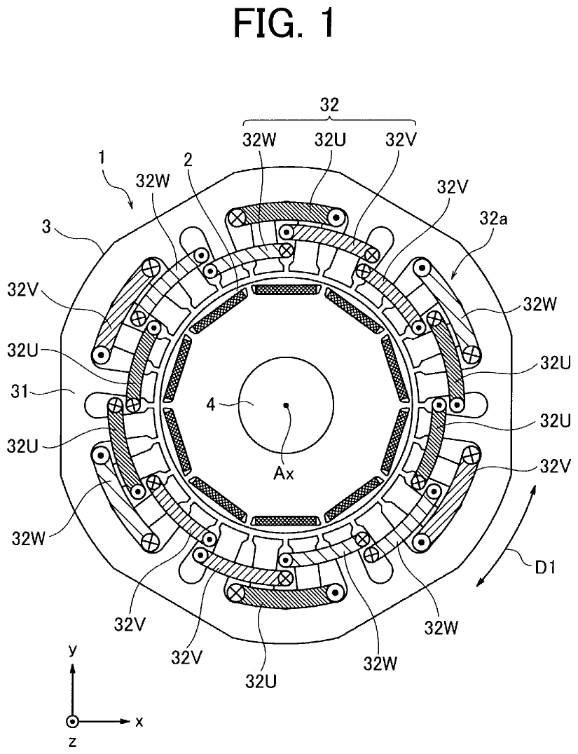

FIG. 1 is a plan view schematically illustrating a structure of the electric motor 1 according to a first embodiment.

The electric motor 1 includes the rotor 2 having a plurality of magnetic poles, the stator 3, and a shaft 4 fixed to the rotor 2. The electric motor 1 is, for example, a permanent magnet synchronous motor.

The rotor 2 is rotatably disposed inside the stator 3. An air gap is present between the rotor 2 and the stator 3. The rotor 2 rotates about the axis Ax.

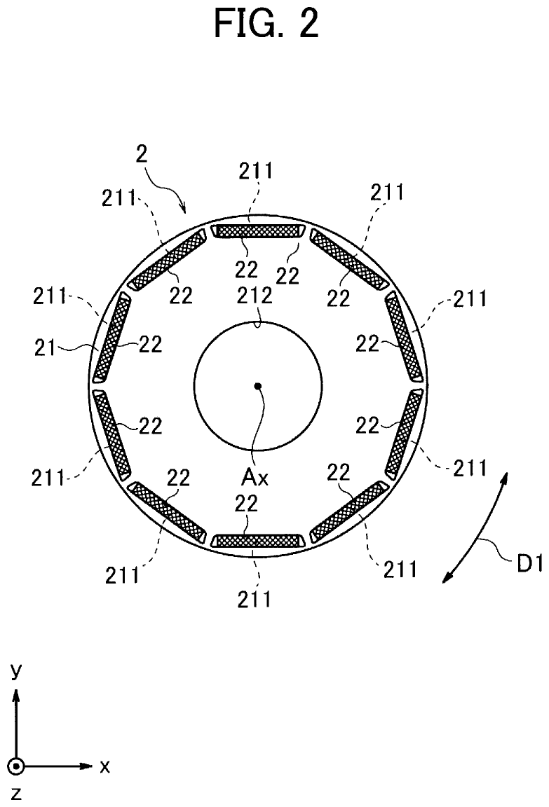

FIG. 2 is a cross-sectional view schematically illustrating a structure of the rotor 2.

The rotor 2 includes a rotor core 21 and a plurality of permanent magnets 22.

The rotor core 21 includes a plurality of magnet insertion holes 211 and a shaft hole 212 in which the shaft 4 is disposed. The rotor core 21 may further include at least one flux barrier portion that is a space communicating with each of the magnet insertion holes 211.

In this embodiment, the rotor 2 includes the plurality of permanent magnets 22. Each of the permanent magnets 22 is disposed in a corresponding one of the magnet insertion holes 211.

One permanent magnet 22 forms one magnetic pole, that is, a north pole or a south pole, of the rotor 2. It should be noted that two or more permanent magnets 22 may form one magnetic pole of the rotor 2.

In this embodiment, in the xy plane, one permanent magnet 22 forming one magnetic pole of the rotor 2 is disposed straight. Alternatively, in the xy plane, a pair of permanent magnets 22 forming one magnetic pole of the rotor 2 may be disposed in a V shape.

A center of each magnetic pole of the rotor 2 is located at a center of each magnetic pole of the rotor 2 (i.e., a north pole or a south pole of the rotor 2). Each magnetic pole of the rotor 2 (hereinafter simply referred to as “each magnetic pole” or a “magnetic pole”) refers to a region serving as a north pole or a south pole of the rotor 2.

### <Stator 3>

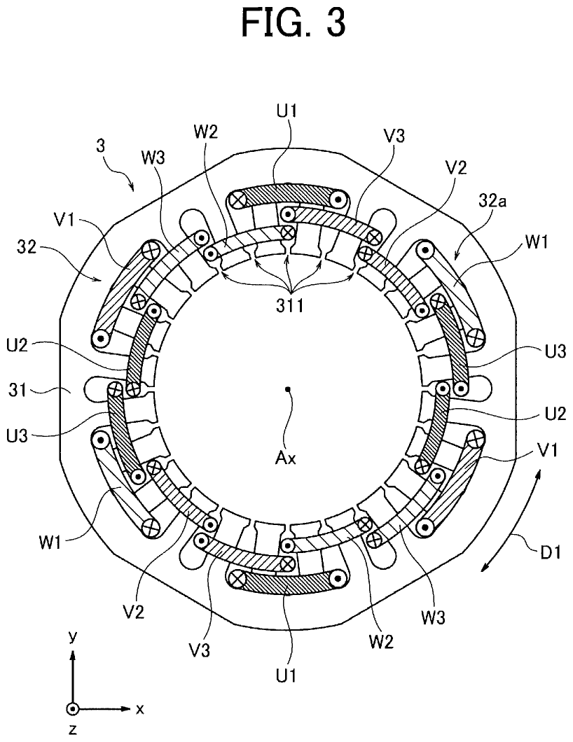

FIG. 3 is a plan view schematically illustrating a structure of the stator 3.

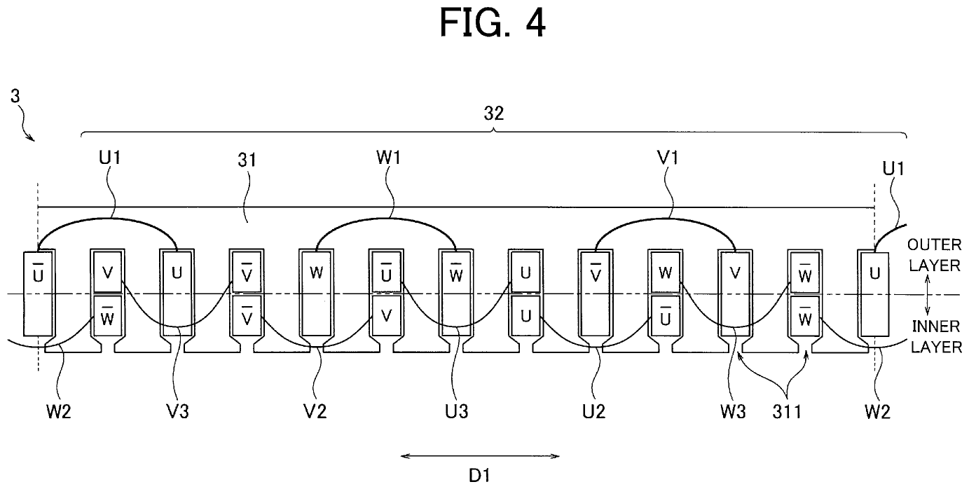

FIG. 4 is a diagram schematically illustrating arrangement of three-phase coils 32 in a coil end 32a and arrangement of the three-phase coils 32 in slots 311. In FIG. 4, broken lines indicate coils of each phase in the coil end 32a, and a chain line indicates a boundary between inner layers and outer layers in the slots 311.

As illustrated in FIG. 3, the stator 3 includes a stator core 31 and the three-phase coils 32 attached to the stator core 31 by distributed winding.

The stator core 31 includes an annular yoke, a plurality of teeth extending from the yoke in the radial direction, and 24×n (n is an integer equal to or larger than 1) slots 311 in which the three-phase coils 32 are disposed. Each slot will also be referred to as a first slot, a second slot, . . . , and an N-th slot, for example. As illustrated in FIG. 4, each of the 24×n slots 311 includes an inner layer in which one of the three-phase coils 32 is disposed, and an outer layer which is located outward from the inner layer in the radial direction and in which one of the three-phase coils 32 is disposed. That is, in the example illustrated in FIG. 4, space in each slot 311 is divided into the inner layer and the outer layer. In this embodiment, n=1. Thus, in the example illustrated in FIG. 3, the stator core 31 includes 24 slots 311.

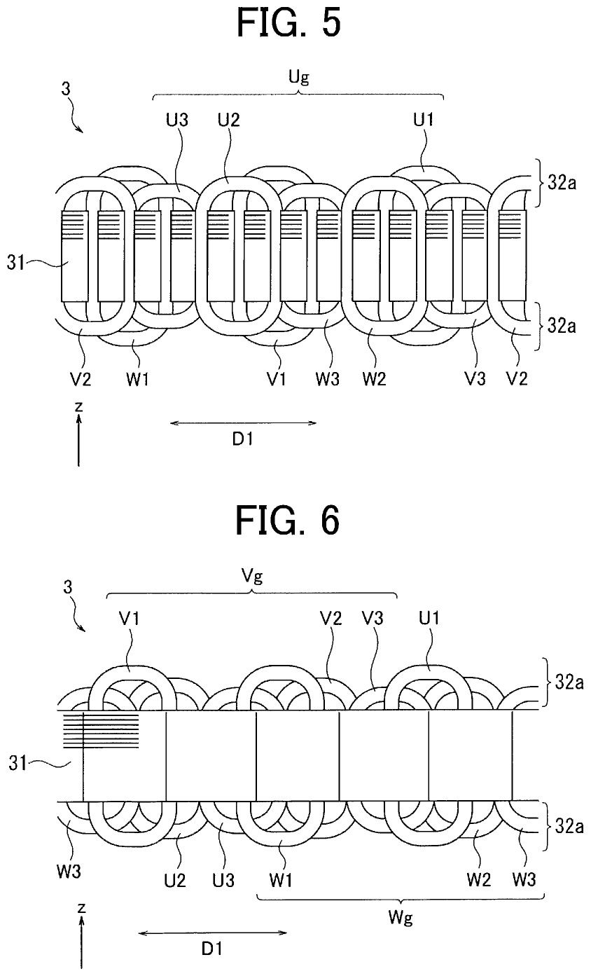

FIG. 5 is a diagram schematically illustrating a structure of the stator 3 seen from the center of the stator 3.

FIG. 6 is a diagram schematically illustrating a structure of the stator 3 seen from the outside of the stator 3.

The three-phase coils 32 (i.e., coils of individual phases) include coil sides located in the slots 311 and coil ends 32a not located in the slots 311. The coil ends 32a are end portions of the three-phase coils 32 in the axial direction.

The three-phase coils 32 include 6×n U-phase coils 32U, 6×n V-phase coils 32V, and 6×n W-phase coils 32W in each coil end 32a (FIG. 1). That is, the three-phase coils 32 have three phases of a first phase, a second phase, and a third phase. For example, the first phase is a U phase, the second phase is a V phase, and the third phase is a W phase. In this embodiment, the three phases will be referred to as the U phase, the V phase, and the W phase, respectively. The U-phase coils 32U, the V-phase coils 32V, and the W-phase coils 32W illustrated in FIG. 1 will also be referred to simply as coils.

In this embodiment, n=1. Thus, in the example illustrated in FIG. 1, in the coil ends 32a, the three-phase coils 32 include six U-phase coils 32U, six V-phase coils 32V, and six W-phase coils 32W. The number of coils of each phase are not limited to six. In this embodiment, the stator 3 has the structure illustrated in FIG. 3 in two coil ends 32a. The stator 3 only needs to have the structure illustrated in FIG. 3 in one of the two coil ends 32a.

When current flows in the three-phase coils 32, the three-phase coils 32 form 10×n magnetic poles. In this embodiment, n=1. Thus, in this embodiment, when current flows in the three-phase coils 32, the three-phase coils 32 form 10 magnetic poles.

As illustrated in FIG. 3, in the coil ends 32a, three U-phase coils 32U arranged in the circumferential direction will be referred to as a first coil U1, a second coil U2, and a third coil U3, respectively. As illustrated in FIG. 3, in the coil ends 32a, three V-phase coils 32V arranged in the circumferential direction will be referred to as a first coil V1, a second coil V2, and a third coil V3, respectively. As illustrated in FIG. 3, in the coil ends 32a, three W-phase coils 32W arranged in the circumferential direction will be referred to as a first coil W1, a second coil W2, and a third coil W3, respectively. Each first coil U1, each second coil U2, each third coil U3, each first coil V1, each second coil V2, each third coil V3, each first coil W1, each second coil W2, and each third coil W3 will also be referred to simply as a coil respectively.

### <U-Phase Coils 32U>

The 6×n U-phase coils 32U include 2×n sets of coil groups Ug each including a set of the first to third coils U1, U2, and U3 arranged in the circumferential direction in each coil end 32a. As illustrated in FIG. 5, the six U-phase coils 32U include two sets of coil groups Ug each including a set of the first to third coils U1, U2, and U3 arranged in the circumferential direction in each coil end 32a. In other words, the six U-phase coils 32U include two sets of coil groups Ug, and each coil group Ug of the six U-phase coils 32U includes the first coil U1, the second coil U2, and the third coil U3 arranged in the circumferential direction in each coil end 32a.

In each coil end 32a, 2×n sets of coil groups Ug of the six U-phase coils 32U are arranged at regular intervals in the circumferential direction of the stator 3. In each coil end 32a, the first coil U1, the second coil U2, and the third coil U3 of each coil group Ug are arranged in this order in the circumferential direction of the stator 3. The first coils U1 are disposed in the stator core 31 at two-slot pitch, the second coils U2 are disposed in the stator core 31 at two-slot pitch, and the third coils U3 are disposed in the stator core 31 at two-slot pitch. In each coil end 32a, the second coil U2 of each coil group Ug is adjacent to the first coil U1 with two slots 311 interposed therebetween.

The two-slot pitch means “each two slots.” That is, the two-slot pitch means that one coil is disposed for each two slots in the slots 311. In other words, the two-slot pitch means that one coil is disposed in the slots 311 with one slot in between.

The first coil U1, the second coil U2, and the third coil U3 of each coil group Ug are connected in series, for example.

### <V-Phase Coils 32V>

The 6×n V-phase coils 32V include 2×n sets of coil groups Vg each including a set of the first to third coils V1, V2, and V3 arranged in the circumferential direction in each coil end 32a. In the example illustrated in FIG. 5, the six V-phase coils 32V include two sets of coil groups Vg each including a set of the first to third coils V1, V2, and V3 arranged in the circumferential direction in each coil end 32a. In other words, the six V-phase coils 32V include two sets of coil groups Vg, and each coil group Vg of the six V-phase coils 32V includes the first coil V1, the second coil V2, and the third coil V3 arranged in the circumferential direction in each coil end 32a.

In each coil end 32a, 2×n sets of coil groups Vg of the six V-phase coils 32V are arranged at regular intervals in the circumferential direction of the stator 3. In each coil end 32a, the first coil V1, the second coil V2, and the third coil V3 of each coil group Vg are arranged in that order in the circumferential direction of the stator 3. The first coils V1 are disposed in the stator core 31 at two-slot pitch, the second coils V2 are disposed in the stator core 31 at two-slot pitch, and the third coils V3 are disposed in the stator core 31 at two-slot pitch. In the coil ends 32a, the second coil V2 of each coil group Vg is adjacent to the first coil V1 with two slots 311 interposed therebetween.

The first coil V1, the second coil V2, and the third coil V3 of each coil group Vg are connected in series, for example.

### <W-Phase Coils 32W>

The 6×n W-phase coils 32W include 2×n sets of coil groups Wg each including a set of the first to third coils W1, W2, and W3 arranged in the circumferential direction in each coil end 32a. In the example illustrated in FIG. 5, the six W-phase coils 32W include two sets of coil groups Wg each including a set of the first to third coils W1, W2, and W3 arranged in the circumferential direction in each coil end 32a. In other words, the six W-phase coils 32W include two sets of coil groups Wg, and each coil group Wg of the six W-phase coils 32W includes the first coil W1, the second coil W2, and the third coil W3 arranged in the circumferential direction in each coil end 32a.

In each coil end 32a, 2×n sets of coil groups Wg of the six W-phase coils 32W are arranged at regular intervals in the circumferential direction of the stator 3. In each coil end 32a, the first coil W1, the second coil W2, and the third coil W3 of each coil group Wg are arranged in this order in the circumferential direction of the stator 3. The first coils W1 are disposed in the stator core 31 at two-slot pitch, the second coils W2 are disposed in the stator core 31 at two-slot pitch, and the third coils W3 are disposed in the stator core 31 at two-slot pitch. In each coil end 32a, the second coil W2 of each coil group Wg is adjacent to the first coil W1 with two slots 311 interposed therebetween.

The first coil W1, the second coil W2, and the third coil W3 of each coil group Wg are connected in series, for example.

<Arrangement of Coils in Coil End 32a>

Arrangement of the three-phase coils 32 in the coil ends 32a will be specifically described below. As described above, the 6×n U-phase coils 32U, the 6×n V-phase coils 32V, and the 6×n W-phase coils 32W each include 2×n sets of coil groups each including a set of first to third coils. In the coil ends 32a, the 2×n sets of coil groups are arranged at regular intervals in the circumferential direction of the stator 3. In each phase, one set of coil groups (also referred to as each coil group) is three coils arranged in the circumferential direction.

In each coil end 32a of each phase, first to third coils constituting each coil group are arranged in this order in the circumferential direction of the stator 3. In the example illustrated in FIG. 3, in the coil ends 32a of each phase, the first coil, the second coil, and the third coil constituting each coil group are arranged counterclockwise in that order. Alternatively, in each coil end 32a of each phase, the first coil, the second coil, and the third coil constituting each coil group may be arranged clockwise in that order.

At least two coils of each coil group of each phase partially overlap each other in the radial direction. In this embodiment, in each coil group, the second coil and the third coil partially overlap each other in the radial direction. In other words, in each coil group, a part of the second coil and a part of the third coil overlap each other in the radial direction.

In each coil end 32a of the three-phase coils 32, a region where the first to third coils of each coil group is divided into an inner region, an intermediate region, and an outer region. The inner region is a region closest to the center of the stator core 31. The outer region is a region farthest from the center of the stator core 31. The intermediate region is a region between the inner region and the outer region. That is, the intermediate region is a region located outward from the inner region in the xy plane, and the outer region is a region located outward from the intermediate region in the xy plane. Each of the inner region, the intermediate region, and the outer region is a region extending in the circumferential direction.

In this embodiment, in the coil ends 32a, the first coil of each coil group is disposed in the outer region, the second coil is disposed in the inner region, and the third coil is disposed in the intermediate region.

### <Summary of Arrangement of Coils in Slots 311>

The first coils of the coil groups of each phase are disposed in the stator core 31 at two-slot pitch. The second coils of the coil groups of each phase are disposed in the stator core 31 at two-slot pitch. The third coils of the coil groups of each phase are disposed in the stator core 31 at two-slot pitch. Each third coil is connected in series to the adjacent second coil.

The first coil of each coil group of each phase is disposed in the outer layer of the slot 311. Each first coil may be disposed in the outer layer and the inner layer of each slot 311.

The second coil of each coil group of each phase is disposed in the inner layer of the slot 311. In each coil group of each phase, a part of the second coil is disposed in the slot 311 where a part of the third coil is disposed.

The third coil of each coil group of each phase is disposed in the outer layer of the slot 311. In each coil group of each phase, a part of the third coil is disposed in the slot 311 where a part of the second coil is disposed.

### <Arrangement of U-Phase Coils 32U in Slots 311>

Arrangement of the U-phase coils 32U in the slots 311 will be specifically described.

The n U-phase coils 32U are disposed in the outer layers of the slots 311.

A part of each second coil U2 of the U-phase coils 32U is disposed in the inner layer of the slot 311 in which the third coil U3 of the U-phase coils 32U is disposed. Another part of each second coil U2 of the U-phase coils 32U is disposed in the inner layer of the slot 311 in which the third coil W3 of the W-phase coils 32W is disposed.

A part of each third coil U3 of the U-phase coils 32U is disposed in the outer layer of the slot 311 in which the second coil U2 of the U-phase coils 32U is disposed. Another part of each third coil U3 of the U-phase coils 32U is disposed in the outer layer of the slot 311 in which the second coils V2 of the V-phase coils 32V is disposed.

### <Arrangement of V-Phase Coils 32V in Slots 311>

Arrangement of the V-phase coils 32V in the slots 311 will be specifically described.

The V-phase coils 32V are disposed in the outer layers of the slots 311.

A part of each second coil V2 of the V-phase coils 32V is disposed in the inner layer of the slot 311 in which the third coil V3 of the V-phase coils 32V is disposed. Another part of each second coil V2 of the V-phase coils 32V is disposed in the inner layer of the slot 311 in which the third coil U3 of the U-phase coils 32U is disposed.

A part of each third coil V3 of the V-phase coils 32V is disposed in the outer layer of the slot 311 in which the second coil V2 of the V-phase coils 32V is disposed. Another part of each third coil V3 of the V-phase coils 32V is disposed in the outer layer of the slot 311 in which the second coil W2 of the W-phase coils 32W is disposed.

### <Arrangement of W-Phase Coils 32W in Slots 311>

The W-phase coils 32W are disposed in the outer layers of the slots 311.

A part of each second coil W2 of the W-phase coils 32W is disposed in the inner layer of the slot 311 in which the third coil W3 of the W-phase coils 32W is disposed. Another part of each second coil W2 of the W-phase coils 32W is disposed in the inner layer of the slot 311 in which the third coil V3 of the V-phase coils 32V is disposed.

A part of each third coil W3 of the W-phase coils 32W is disposed in the outer layer of the slot 311 in which the second coil W2 of the W-phase coils 32W is disposed. Another part of each third coil W3 of the W-phase coils 32W is disposed in the outer layer of the slot 311 in which the second coil U2 of the U-phase coils 32U is disposed.

### <Variation of Coil Arrangement>

The “first coil” herein may be read as the “third coil.” In this case, in the example illustrated in FIG. 3, the third coil, the second coil, and the first coil in each coil group are arranged in that order in the circumferential direction of the stator 3 in the coil ends 32a. That is, in the example illustrated in FIG. 3, in each coil end 32a, the third coil, the second coil, and the first coil of each coil group are arranged counterclockwise in that order.

### <Winding Factor>

A short-pitch factor Kp of each coil is obtained in the following equation:

Kp=sin[{S/(Q/P)}×(π/2)×γ]

In this embodiment, P=10, Q=24, and S=2, where P is the number of magnetic poles of the three-phase coils 32, Q is the number of the slots 311, S is the number of slot pitches, and γ is an order of a harmonic. Thus, the short-pitch factor Kp of a fundamental wave component (γ=1) is 0.966.

In each coil group of each phase, a distributed winding factor Kd1 of the first coil is 1 with reference to a phase of an induced voltage occurring in the first coil. A distributed winding factor Kd2 of a fundamental wave component of the second coil is obtained by the following equation:

Kd2={sin(γ×π/6)}×(1/q)×[1/sin{γ×(π/6)/q}]

where q is the number of slots per pole per phase.

In this embodiment, q=2. Thus, Kd2=) sin30°×(½)×(1/sin15°=0.966

In this embodiment, q=2. Thus, Kd2=) sin30°×(½)×(1/sin15°=0.966

A distributed winding factor Kd3 of a fundamental wave component of the third coil is equal to the distributed winding factor Kd2 of the fundamental wave component of the second coil. Thus, Kd3=0.966.

In each coil group of each phase, in a case where the number of turns of the second coil is a half of the number of turns of the first coil and the number of turns of the third coil is a half of the number of turns of the first coil, a winding factor Kw of a fundamental wave component in the stator 3 is obtained by the following equation:

Kw=Kp×(Kd1×2+Kd2+Kd3)/4=0.949

### <Insulator>

The stator 3 may include an insulator that insulates coils of each phase of the three-phase coils 32. The insulator is, for example, insulating paper.

### <Number of Turns of Coil in First Embodiment>

In each coil group of each phase, the sum of the number of turns of the second coil and the number of turns of the third coil is preferably equal to the number of turns of the first coil.

### <Method for Fabricating Stator 3 in First Embodiment>

An example of a method for fabricating the stator 3 will be described.

An example of a method for fabricating the stator 3 will be specifically described below.

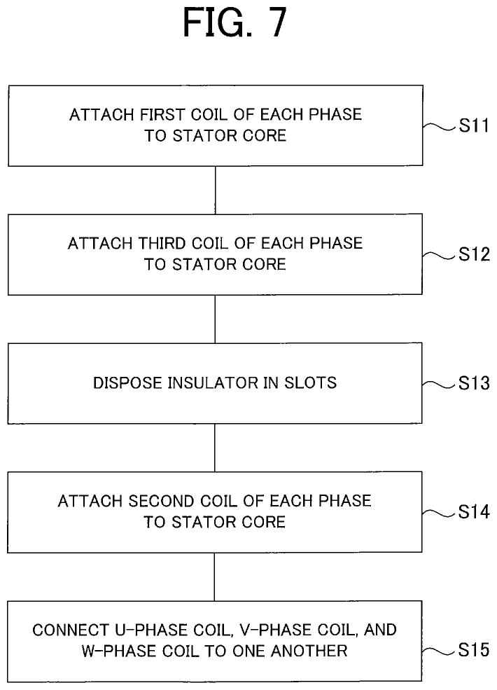

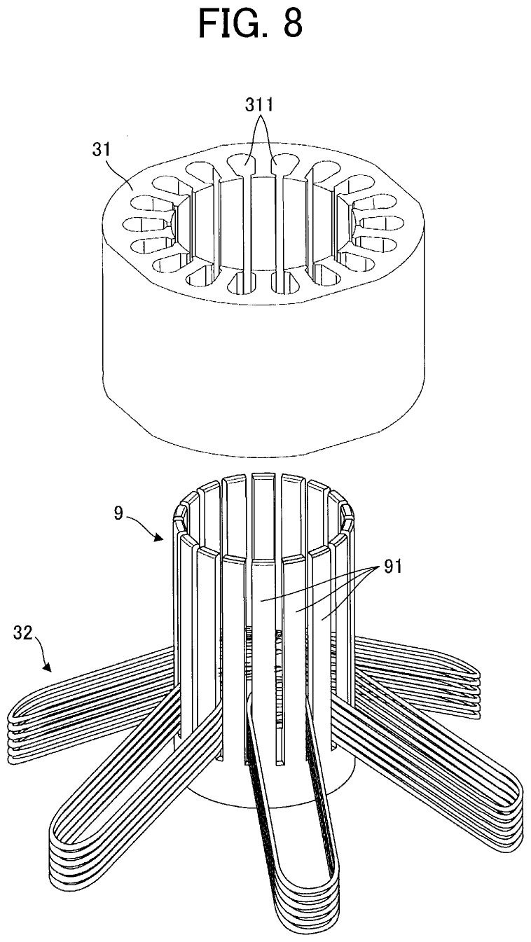

FIG. 7 is a flowchart showing an example of a process of fabricating the stator 3 according to the first embodiment.

FIG. 8 is a diagram illustrating an example of an inserter 9 for inserting the three-phase coils 32 in the stator core 31.

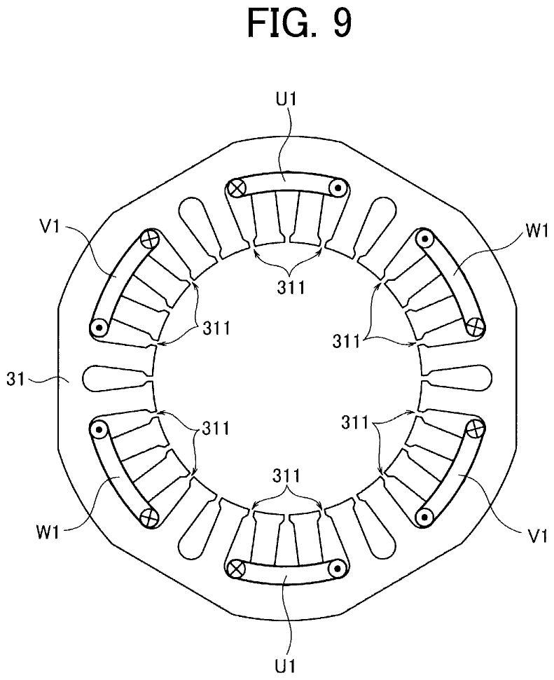

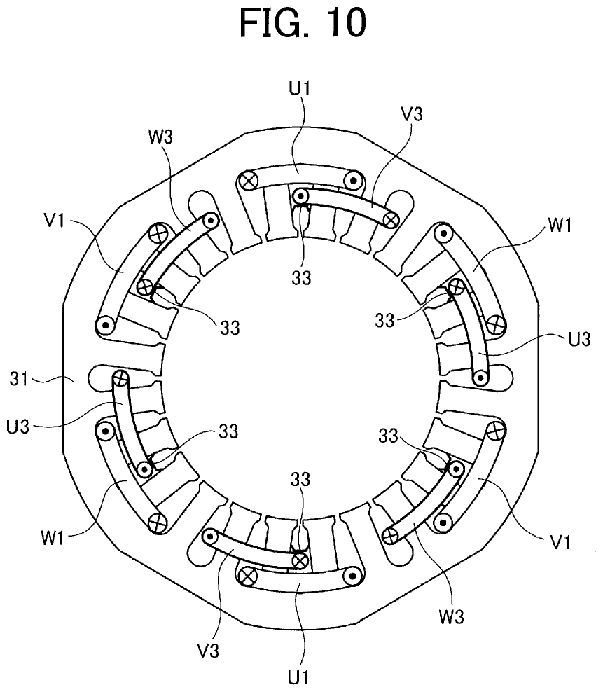

FIG. 9 is a diagram illustrating an insertion step of first coils in step S11.

In step S11, as illustrated in FIG. 9, the first coils of each phase are attached to a previously prepared stator core 31 by the inserter 9. Specifically, the first coils of each phase are disposed at regular intervals in the circumferential direction in the coil ends 32a, and disposed in the outer layers of the slots 311 of the stator core 31 by distributed winding. That is, the first coils U1 of the U-phase coils 32U, the first coils V1 of the V-phase coils 32V, and the first coils W1 of the W-phase coils 32W are disposed in the outer layers of the slots 311 by distributed winding. Consequently, the first coil of each coil group of each phase is disposed in the outer region of the coil ends 32a.

In the case of inserting the three-phase coils 32 in the stator core 31 by the inserter 9 illustrated in FIG. 8, the coils are disposed between blades 91 of the inserter 9, and the blades 91 are inserted in the inside of the stator core 31 together with the coils. Next, the coils are caused to slide in the axial direction to be disposed in the slots 311. In subsequent steps S12 and S14 described later, the three-phase coils 32 are inserted in the stator core 31 in the same manner.

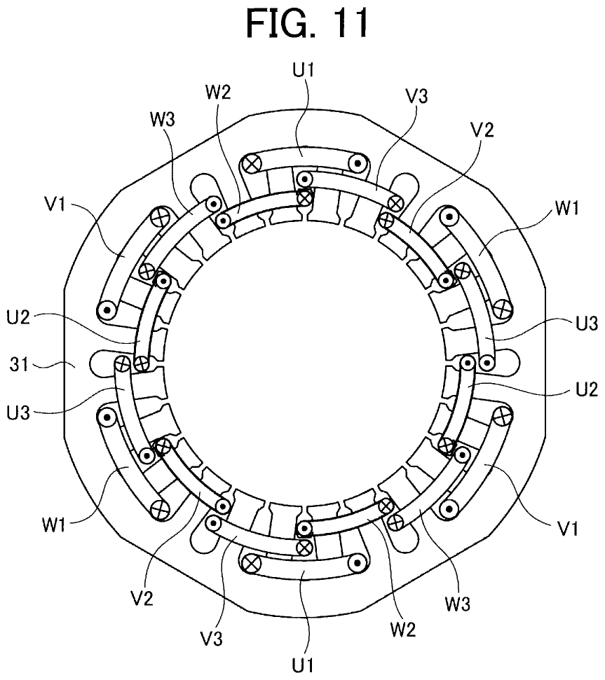

FIG. 10 is a diagram illustrating an insertion step of third coils in step S12.

In step S12, as illustrated in FIG. 10, third coils of each phase are attached to the stator core 31 by the inserter 9. Specifically, the third coils of each phase are disposed at regular intervals in the circumferential direction in the coil ends 32a, and disposed by distributed winding in the outer layers of the slots 311 where coils are not disposed. Consequently, the third coil of each coil group of each phase is disposed in the intermediate region of the coil ends 32a.

In step S13, the insulator 33 is disposed in the slots 311 where the third coils of each phase are disposed to insulate the third coils of each phase. Specifically, the insulator 33 is disposed in six slots 311 where the second coils of different phases are to be disposed in the next step.

FIG. 11 is a diagram illustrating an insertion step of second coils in step S14.

In step S14, as illustrated in FIG. 11, second coils of each phase are attached to the stator core 31 by the inserter 9. Specifically, in the coil ends 32a, the second coils of each phase are arranged at regular intervals in the circumferential direction, and are disposed in the inner layers of the slots 311 by distributed winding. That is, the second coils U2 of the U-phase coils 32U, the second coils V2 of the V-phase coils 32V, and the second coils W2 of the W-phase coils 32W are disposed in the inner layers of the slots 311 by distributed winding. Consequently, the second coil of each coil group of each phase is disposed in the inner region of the coil ends 32a.

Specifically, a part of the second coils U2 of the U-phase coils 32U is disposed in the inner layers of the slots 311 in which a part of the third coils U3 is disposed. That is, the second coils U2 are disposed in the stator core 31 at two-slot pitch such that a part of the third coils U3 and a part of the second coils U2 are disposed in the same slots 311.

A part of the second coils V2 of the V-phase coils 32V is disposed in the inner layers of the slots 311 in which a part of the third coils V3 is disposed. That is, the second coils V2 are disposed in the stator core 31 at two-slot pitch such that a part of the third coils V3 and a part of the second coils V2 are disposed in the same slots 311.

A part of the second coils W2 of the W-phase coils 32W is disposed in the inner layers of the slots 311 in which a part of the third coils W3 is disposed. That is, the second coils W2 are disposed in the stator core 31 at two-slot pitch such that a part of the third coils W3 and a part of the second coils W2 are disposed in the same slots 311.

As described above, in steps S11 to S14, the first coils are disposed in the stator core 31 at two-slot pitch by distributed winding, the second coils are disposed in the stator core 31 at two-slot pitch by distributed winding, and the third coils are disposed in the stator core 31 at two-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S15, the U-phase coils 32U, the V-phase coils 32V, and the W-phase coils 32W are connected to one another. Thereafter, the shape of the connected three-phase coils 32 are appropriately adjusted. Consequently, the stator 3 illustrated in FIG. 3 is obtained.

### <Advantages of Stator 3 in First Embodiment>

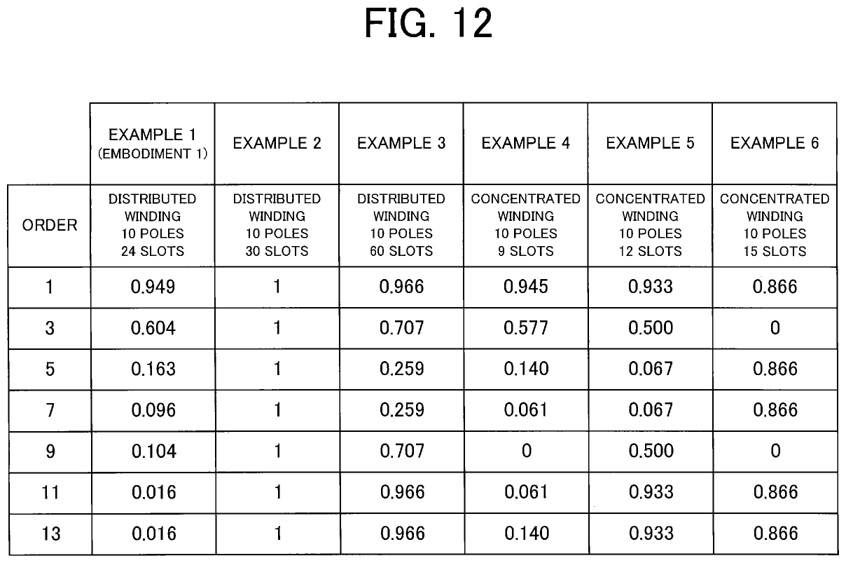

FIG. 12 is a table showing a comparison of winding factors.

Example 1 is the stator 3 according to the first embodiment.

Example 2 is a stator with full-pitch winding by distributed winding. In Example 2, a winding factor of a fundamental wave component (i.e., an order of 1) is large, but a winding factor of a harmonic component is also large. Thus, if magnetic flux density distribution in the surface of the rotor has a large amount of distortion, an induced voltage occurring in three-phase coils includes a large amount of harmonics.

Example 3 is a stator whose winding factor in distributed winding is not one. Since fifth and seventh harmonic components have small winding factors, distortion of the induced voltage can be reduced. However, since the number of slots is large, the area of the stator core facing the rotor is small. Consequently, it is difficult to interlink magnetic flux from the rotor with the three-phase coils effectively.

Example 4 is a stator by concentrated winding. The winding factor of a fundamental wave component is large, and winding factors of fifth and seventh harmonic components are small. Since Example 4 is the stator by concentrated winding, an electromagnetic force in the radial direction is large. Thus, as an output of the electric motor increases, vibrations and noise in the electric motor increase.

Example 5 is a stator by concentrated winding. A winding factor of a fundamental wave component is relatively large, and winding factors of harmonic components (fifth, seventh, eleventh, and thirteenth) are small. Example 5 includes the second coils and third coils described in the first embodiment. The stator core is easily deformed by an electromagnetic force occurring in supplying current to the three-phase coils. In a case where current includes distortion, vibrations and noise due to vibrations of the stator core are likely to occur in the electric motor.

Example 6 is a stator by concentrated winding. Although a winding factor of a fundamental wave component is small, a winding factor of a harmonic component is large. Since the peripheral length of three-phase coils can be reduced in concentrated winding, a copper loss can be significantly reduced. However, in the stator with concentrated winding, coil ends are larger than those in a stator with distributed winding. Consequently, the size of the electric motor increases.

In general, many electric motors for use in compressors (e.g., synchronous motors) employ sintered rare earth magnets. In this case, to reduce costs for materials, a flat-plate permanent magnets are often disposed inside the rotor core. Thus, since the outer peripheral surface of the rotor is constituted by the rotor core, magnetic flux density distribution in the surface of the rotor is likely to change rapidly, and a harmonic component in a higher order is likely to occur in an induced voltage occurring in three-phase coils of the stator.

In this embodiment, the winding factor of a fundamental wave component is relatively large, and the winding factor of a harmonic component is small. In particular, winding factors of eleventh and thirteenth harmonic components are small. Thus, even in a case where the rotor 2 is an interior permanent magnet rotor (IPM rotor), distortion of an induced voltage occurring in the three-phase coils 32 can be reduced.

From the viewpoint of energy saving, switching from conventional induction motors to synchronous motors with smaller loss is progressing. In the electric motor 1 including the stator 3 described in this embodiment, vibrations of the electric motor 1 can be reduced. As a result, the electric motor 1 with high efficiency and low noise can be provided.

In addition, in the first embodiment, the first coil of each coil group of each phase is disposed in the outer region in the coil ends 32a. Thus, the contact area of the first coils in contact with coils of another phase can be reduced. Accordingly, an electromagnetic force generated between coils when current is supplied to the three-phase coils 32 can be reduced, and thus vibrations in the electric motor 1 can be reduced. As a result, noise in the electric motor 1 can be reduced.

With the method for fabricating the stator 3 according to the first embodiment, the stator 3 having the advantages described in this embodiment can be fabricated. In addition, with the method for fabricating the stator 3, the three-phase coils 32 can be attached to the stator core 31 by using the inserter 9. In addition, since the first coils are first disposed in the outer region, the second coils and the third coils can be easily disposed in the stator core 31, and a height of the coil ends 32a in the axial direction can be reduced.

Furthermore, in a case where the number of turns of each second coil is smaller than the number of turns of each first coil and the number of each third coil is smaller than the number of turns of each first coil, the volume of each second coil is smaller than the volume of each first coil, and the volume of each third coil is smaller than the volume of each first coil. In this case, the shapes of the second coils and the third coils can be easily adjusted, the second coils and the third coils can be easily disposed in the stator core 31.

### Variations

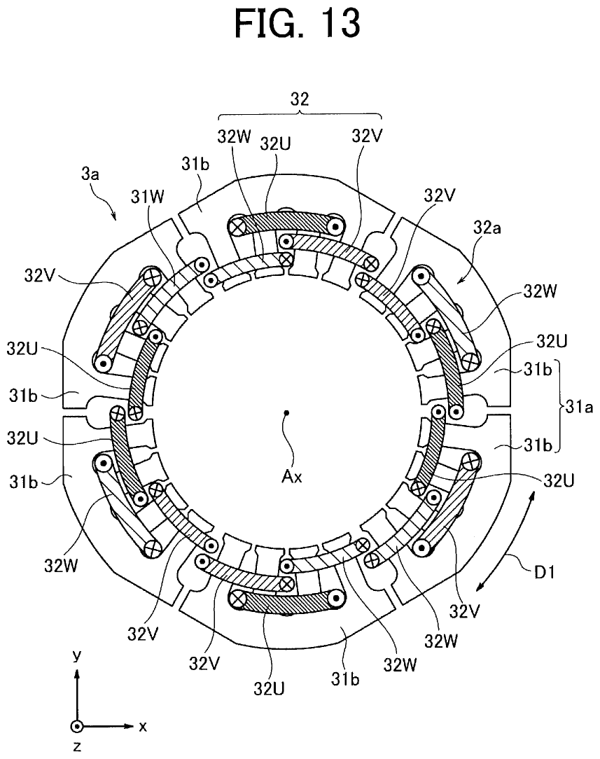

FIG. 13 is a diagram illustrating another example of the stator core 31 in the first embodiment. Arrangement of the three-phase coils 32 illustrated in FIG. 13 is the same as arrangement of the three-phase coils 32 illustrated in FIG. 1.

The stator 3 may include a stator core 31a instead of the stator core 31. The stator core 31a is divided into a plurality of divided cores 31b. That is, the stator core 31a is divided into the plurality of divided cores 31b. Each of the divided cores 31b includes at least one slot 311.

The stator core 31a is divided into the plurality of divided cores 31b in the slot 311 where a part of the second coil and a part of the third coil of each coil group of each phase are disposed. In the example illustrated in FIG. 13, the stator core 31a is divided into six divided cores 31b. Coils of different phases are attached to each divided core 31b. The stator core 31a in this variation has the advantage of easiness in disposing the three-phase coils 32 in the stator core 31a. In the process of fabricating the stator 3 using the stator core 31a, after the three-phase coils 32 are disposed in the divided cores 31b, the divided cores 31b are coupled to each other, and the coils are connected.

### Second Embodiment

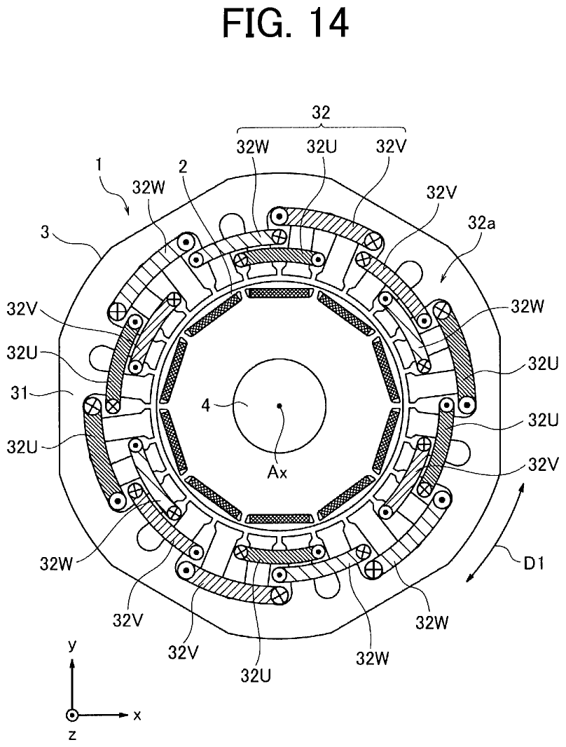

FIG. 14 is a plan view schematically illustrating a structure of an electric motor 1 according to a second embodiment.

In the second embodiment, arrangement of three-phase coils 32 is different from that described in the first embodiment. In the second embodiment, a part of the configuration different from that of the first embodiment will be described. Details not described in the second embodiment are the same as those in the first embodiment.

### <Stator 3>

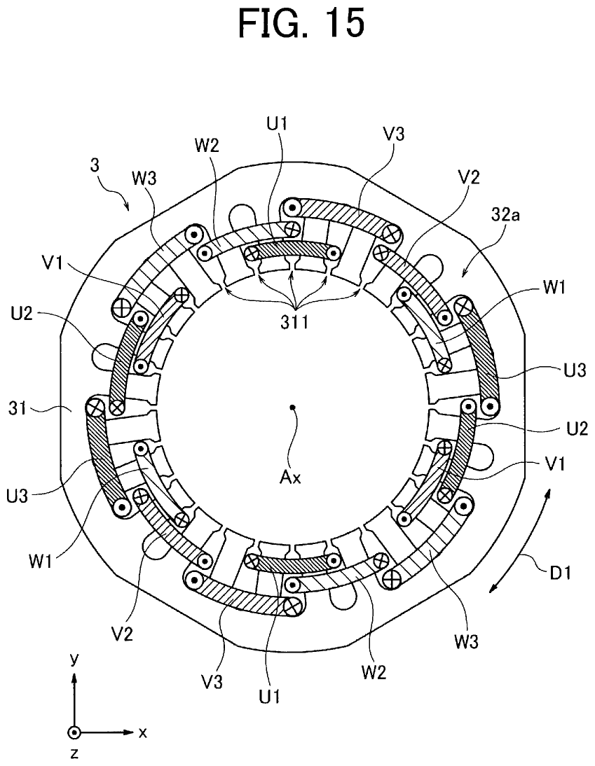

FIG. 15 is a plan view schematically illustrating a structure of a stator 3 according to the second embodiment.

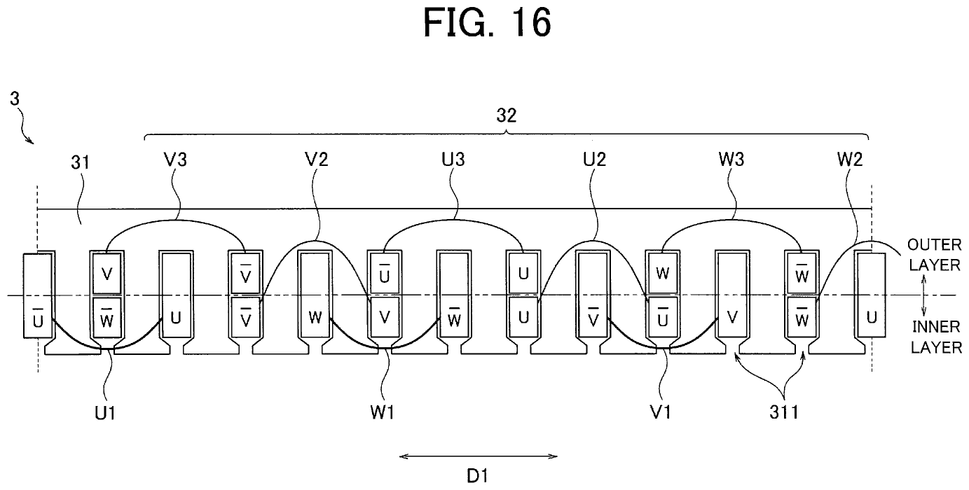

FIG. 16 is a diagram schematically illustrating arrangement of three-phase coils 32 in a coil and 32a and slots 311. In FIG. 16, broken lines indicate coils of phases in the coil end 32a, and a chain line indicates a boundary between inner layers and outer layers in the slots 311.

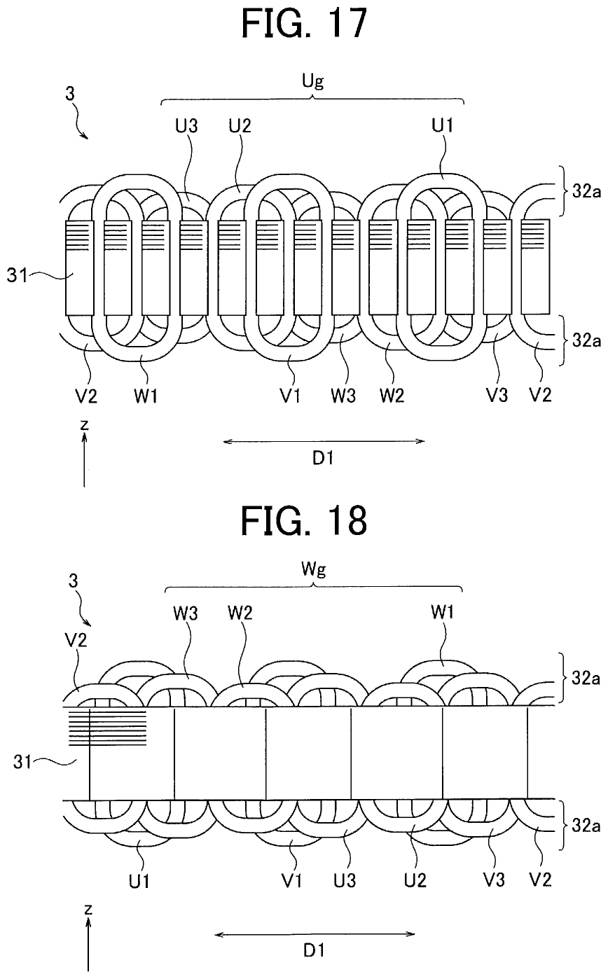

FIG. 17 is a diagram schematically illustrating a structure of the stator 3 illustrated in FIG. 15 seen from the center of the stator 3.

FIG. 18 is a diagram schematically illustrating a structure of the stator 3 illustrated in FIG. 15 seen from the outside of the stator 3.

In the example illustrated in FIGS. 15 and 16, a stator core 31 includes 24 slots 311 in a manner similar to the first embodiment.

<Summary of Arrangement of Coils in Coil End 32a>

In this embodiment, in the coil ends 32a, the first coil of each coil group is disposed in the inner region, the second coil is disposed in the intermediate region, and the third coil is disposed in the outer region.

### <Summary of Arrangement of Coils in Slots 311>

The first coil of each coil group of each phase is disposed in the inner layer of the slot 311. Each first coil may be disposed in the outer layer and the inner layer of each slot 311.

The second coil of each coil group of each phase is disposed in the inner layer of the slot 311. In each coil group of each phase, a part of the second coil is disposed in the slot 311 where a part of the third coil is disposed.

The third coil of each coil group of each phase is disposed in the outer layer of the slot 311. In each coil group of each phase, a part of the third coil is disposed in the slot 311 where a part of the second coil is disposed.

### <Method for Fabricating Stator 3 in Second Embodiment>

An example of a method for fabricating the stator 3 described in the second embodiment will be described.

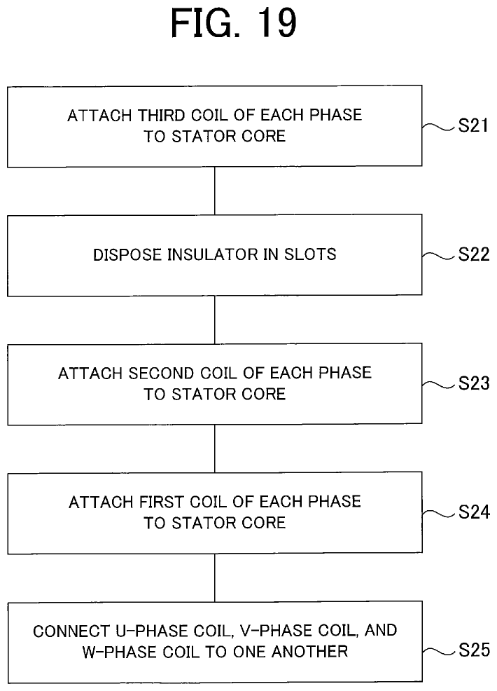

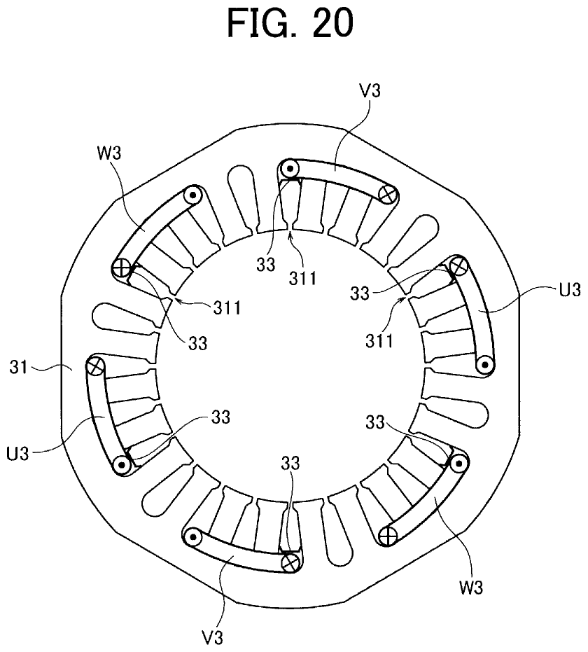

FIG. 19 is a flowchart showing an example of a process of fabricating the stator 3 according to the second embodiment.

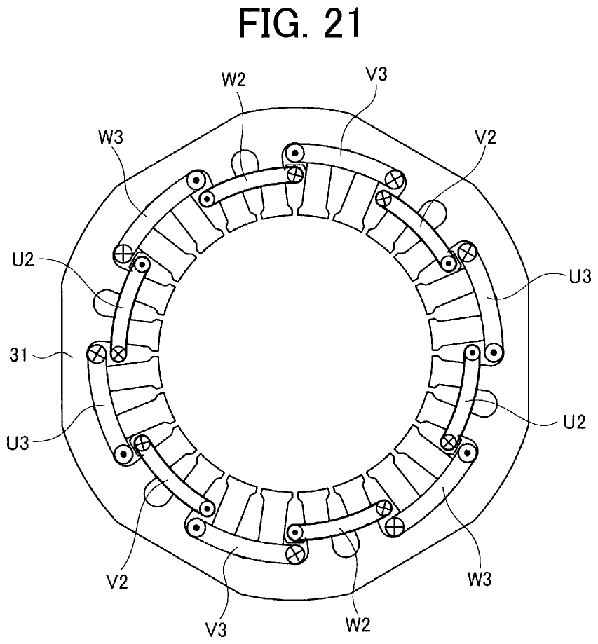

FIG. 20 is a diagram illustrating an insertion step of third coils in step S21.

In step S21, as shown in FIG. 20, third coils of each phase are attached to a previously prepared stator core 31 by the inserter 9. Specifically, the third coils of each phase are disposed at regular intervals in the circumferential direction in the coil ends 32a, and disposed in the outer layers of the slots 311 of the stator core 31 by distributed winding. That is, the third coils U3 of the U-phase coils 32U, the third coils V3 of the V-phase coils 32V, and the third coils W3 of the W-phase coils 32W are disposed in the outer layers of the slots 311 by distributed winding. Consequently, the third coil of each coil group of each phase is disposed in the outer region of the coil ends 32a.

In step S22, the insulator 33 is disposed in the slots 311 where the third coils of each phase are disposed to insulate the third coils of each phase. Specifically, the insulator 33 is disposed in six slots 311 where the second coils of different phases are to be disposed in the next step.

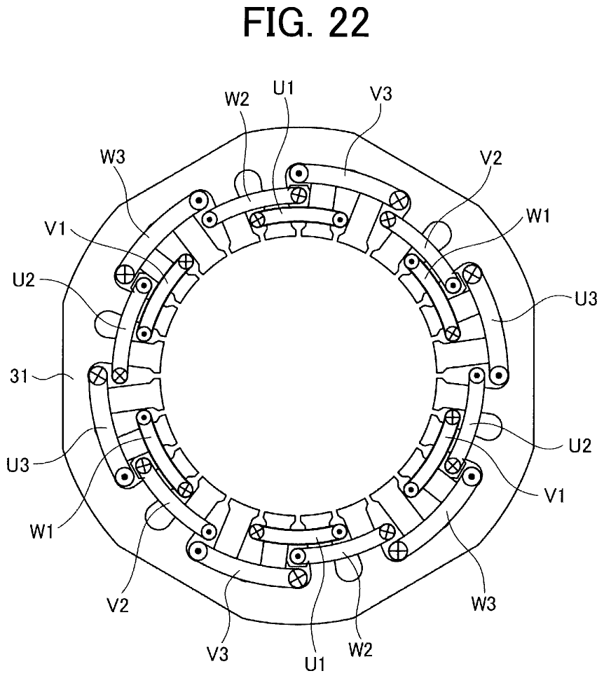

FIG. 21 is a diagram illustrating an insertion step of second coils in step S23.

In step S23, as illustrated in FIG. 21, second coils of each phase are attached to the stator core 31 by the inserter 9. Specifically, in the coil ends 32a, the second coils of each phase are arranged at regular intervals in the circumferential direction, and are disposed in the inner layers of the slots 311 by distributed winding. That is, the second coils U2 of the U-phase coils 32U, the second coils V2 of the V-phase coils 32V, and the second coils W2 of the W-phase coils 32W are disposed in the inner layers of the slots 311 by distributed winding. Consequently, the second coil of each coil group of each phase is disposed in the intermediate region of the coil ends 32a.

Specifically, a part of the second coils U2 of the U-phase coils 32U is disposed in the inner layers of the slots 311 in which a part of the third coils U3 is disposed. That is, the second coils U2 are disposed in the stator core 31 at two-slot pitch such that a part of the third coils U3 and a part of the second coils U2 are disposed in the same slots 311.

A part of the second coils V2 of the V-phase coils 32V is disposed in the inner layers of the slots 311 in which a part of the third coils V3 is disposed. That is, the second coils V2 are disposed in the stator core 31 at two-slot pitch such that a part of the third coils V3 and a part of the second coils V2 are disposed in the same slots 311.

A part of the second coils W2 of the W-phase coils 32W is disposed in the inner layers of the slots 311 in which a part of the third coils W3 is disposed. That is, the second coils W2 are disposed in the stator core 31 at two-slot pitch such that a part of the third coils W3 and a part of the second coils W2 are disposed in the same slots 311.

FIG. 22 is a diagram illustrating an insertion step of first coils in step S24.

In step S24, as illustrated in FIG. 22, first coils of each phase are attached to the stator core 31 by the inserter 9. Specifically, the first coils of each phase are disposed at regular intervals in the circumferential direction in the coil ends 32a, and disposed in the inner layers of the slots 311 of the stator core 31 by distributed winding. That is, the first coils U1 of the U-phase coils 32U, the first coils V1 of the V-phase coils 32V, and the first coils W1 of the W-phase coils 32W are disposed in the inner layers of the slots 311 by distributed winding. Consequently, the first coil of each coil group of each phase is disposed in the inner region of the coil ends 32a.

As described above, in steps S21 to S24, the first coils are disposed in the stator core 31 at two-slot pitch by distributed winding, the second coils are disposed in the stator core 31 at two-slot pitch by distributed winding, and the third coils are disposed in the stator core 31 at two-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S25, the U-phase coils 32U, the V-phase coils 32V, and the W-phase coils 32W are connected to one another. Thereafter, the shape of the connected three-phase coils 32 are appropriately adjusted. Consequently, the stator 3 illustrated in FIG. 15 is obtained.

### <Advantages of Stator 3 in Second Embodiment>

The stator 3 in the second embodiment has the advantages described in the first embodiment. Thus, the electric motor 1 according to the second embodiment has the advantages described in the first embodiment.

In addition, in the second embodiment, the first coil of each coil group of each phase is disposed in the inner region in the coil ends 32a. Thus, the contact area of the first coils in contact with coils of another phase can be reduced. Accordingly, an electromagnetic force generated between coils when current is supplied to the three-phase coils 32 can be reduced, and thus vibrations in the electric motor 1 can be reduced. As a result, noise in the electric motor 1 can be reduced.

With the method for fabricating the stator 3 according to this embodiment, the stator 3 having the advantages described in this embodiment can be fabricated.

The method for fabricating the stator 3 in this embodiment has the advantages described in the first embodiment.

In addition, in the method for fabricating the stator 3 in this embodiment, the third coils and the second coils are disposed in the outer region and the intermediate region, respectively, and then the first coils are disposed in the inner region. In a case where the number of turns of each second coil is smaller than the number of turns of each first coil and the number of turns of each third coil is smaller than the number of turns of each first coil, the volume of each second coil is smaller than the volume of each first coil and the volume of each third coil is smaller than the volume of each first coil. In this case, the shapes of the second coils and the third coils can be easily adjusted, and thus, the second coils and the third coils can be disposed in the stator core 31 beforehand in consideration of the region where the first coils are disposed. As a result, after the second coils and the third coils are disposed in the stator core 31, the first coils can be easily disposed in the stator core 31.

### Third Embodiment

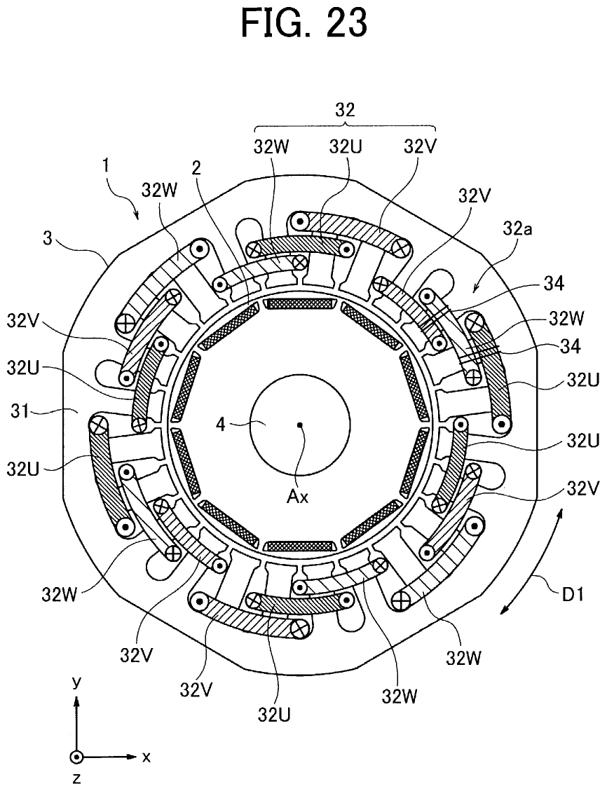

FIG. 23 is a plan view schematically illustrating a structure of an electric motor 1 according to a third embodiment.

In the third embodiment, arrangement of three-phase coils 32 is different from that described in the first embodiment. In the third embodiment, a part of the configuration different from that of the first embodiment will be described. Details not described in the third embodiment are the same as those in the first embodiment.

### <Stator 3>

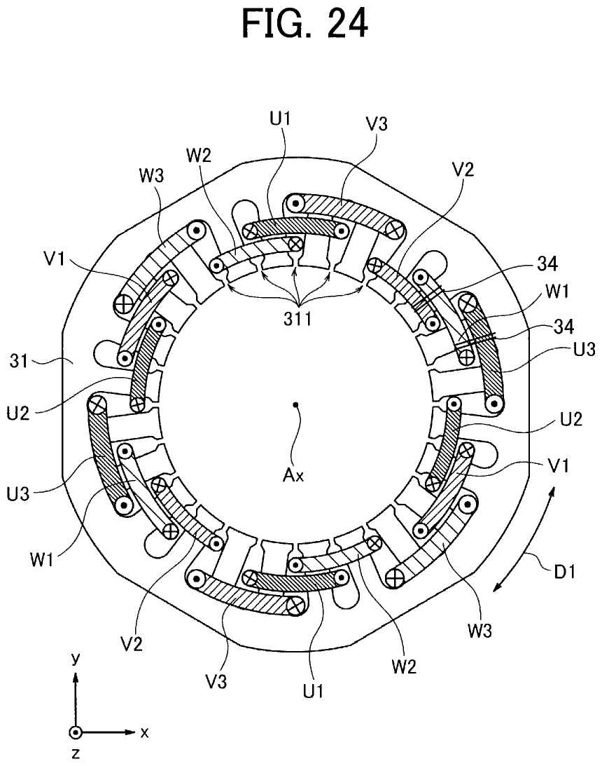

FIG. 24 is a plan view schematically illustrating a structure of a stator 3 according to the third embodiment.

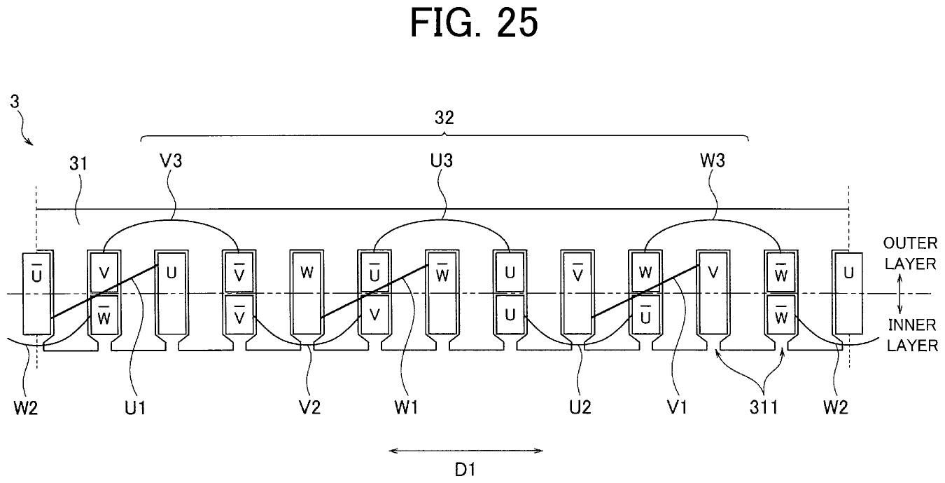

FIG. 25 is a diagram schematically illustrating arrangement of three-phase coils 32 in a coil and 32a and slots 311. In FIG. 25, broken lines indicate coils of phases in the coil end 32a, and a chain line indicates a boundary between inner layers and outer layers in the slots 311.

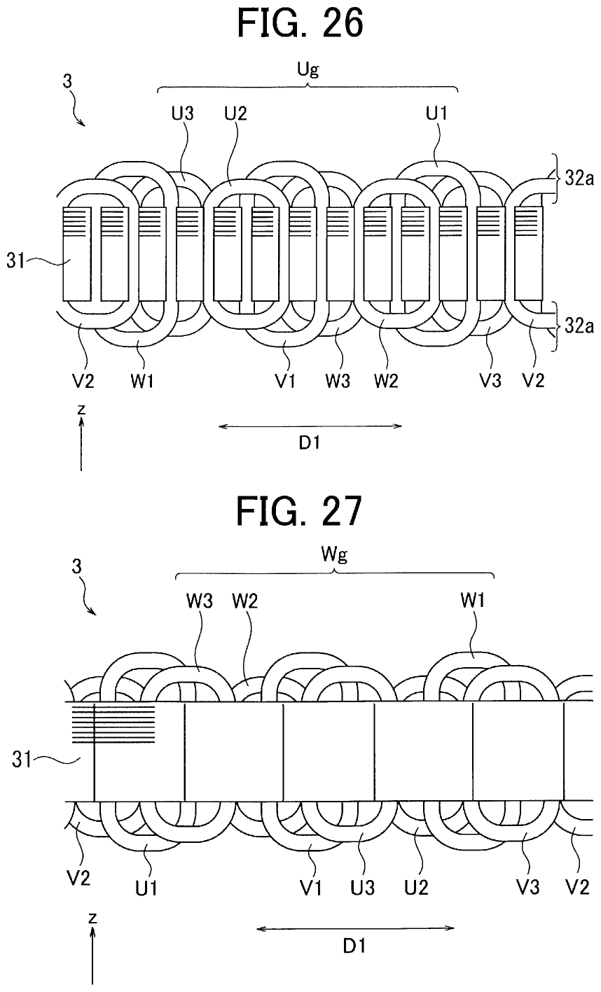

FIG. 26 is a diagram schematically illustrating a structure of the stator 3 illustrated in FIG. 23 seen from the center of the stator 3.

FIG. 27 is a diagram schematically illustrating a structure of the stator 3 illustrated in FIG. 23 seen from the outside of the stator 3.

In the example illustrated in FIGS. 24 and 25, a stator core 31 includes 24 slots 311 in a manner similar to the first embodiment.

The stator 3 may include a cord 34 for fixing coils. In this case, adjacent coils are fixed by the cord 34.

<Summary of Arrangement of Coils in Coil End 32a>

In this embodiment, in the coil ends 32a, the first coil of each coil group is disposed in the intermediate region, the second coil is disposed in the inner region, and the third coil is disposed in the outer region.

### <Arrangement of Coils in Slots 311>

The first coil of each coil group of each phase is disposed in the inner layer or the outer layer of the slot 311. Each first coil may be disposed in the outer layer and the inner layer of each slot 311.

The second coil of each coil group of each phase is disposed in the inner layer of the slot 311. In each coil group of each phase, a part of the second coil is disposed in the slot 311 where a part of the third coil is disposed.

The third coil of each coil group of each phase is disposed in the outer layer of the slot 311. In each coil group of each phase, a part of the third coil is disposed in the slot 311 where a part of the second coil is disposed.

### <Method for Fabricating Stator 3 in Third Embodiment>

An example of a method for fabricating the stator 3 in the third embodiment will be described.

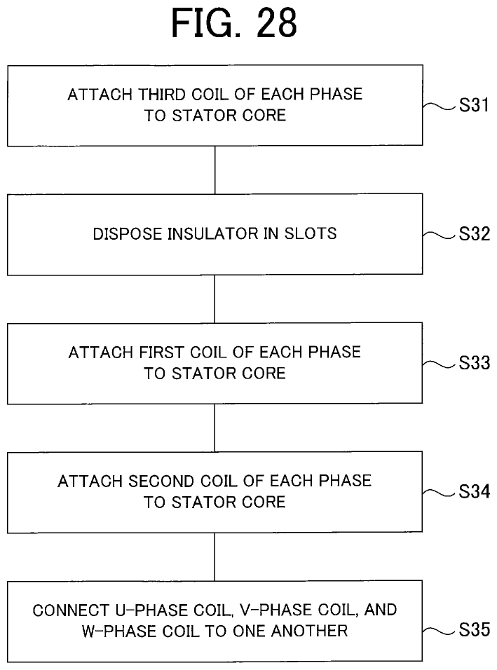

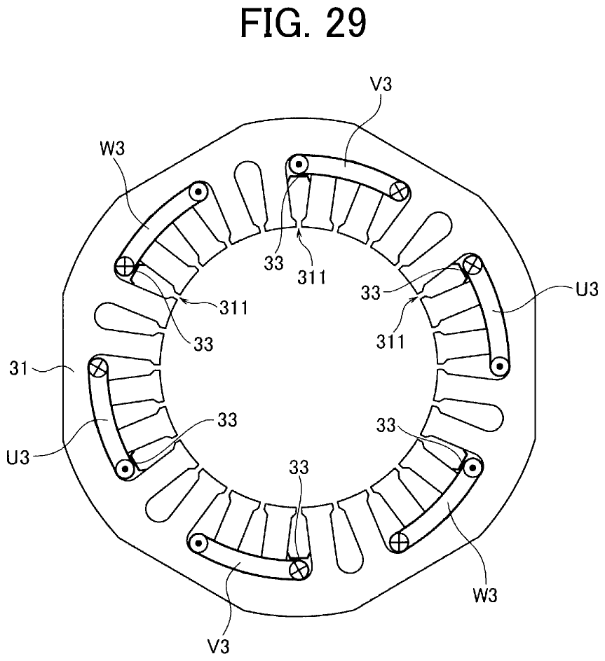

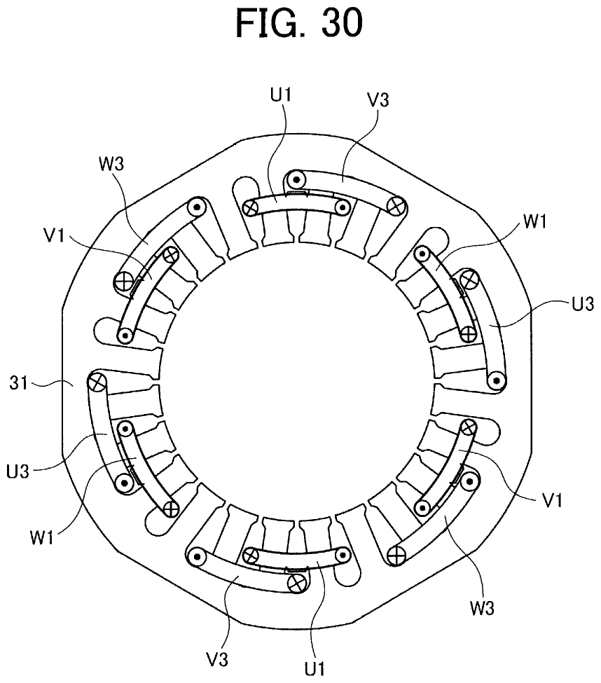

FIG. 28 is a flowchart showing an example of a process of fabricating the stator 3 according to the third embodiment.

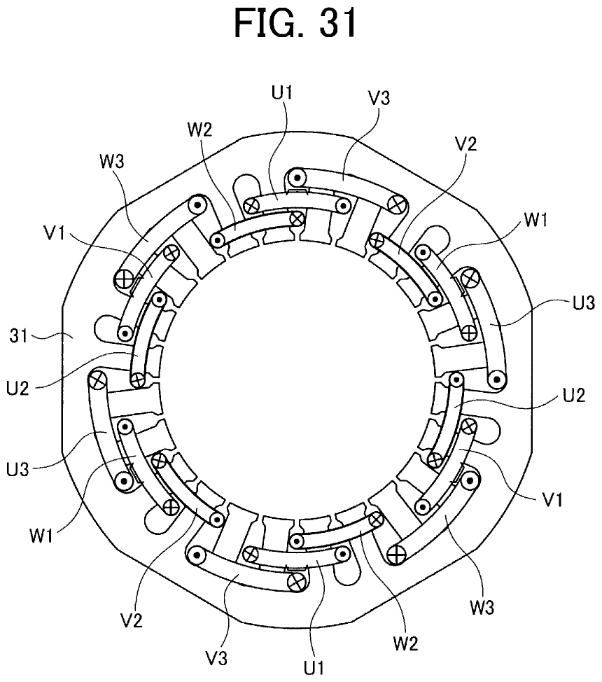

FIG. 29 is a diagram illustrating an insertion step of third coils in step S31.

In step S31, as shown in FIG. 29, third coils of each phase are attached to a previously prepared stator core 31 by the inserter 9. Specifically, in the coil ends 32a, the third coils of each phase are arranged at regular intervals in the circumferential direction, and are disposed in the outer layers of the slots 311 by distributed winding. That is, the third coils U3 of the U-phase coils 32U, the third coils V3 of the V-phase coils 32V, and the third coils W3 of the W-phase coils 32W are disposed in the outer layers of the slots 311 by distributed winding. Consequently, the third coil of each coil group of each phase is disposed in the outer region of the coil ends 32a.

In step S32, the insulator 33 is disposed in the slots 311 where the third coils of each phase are disposed to insulate the third coils of each phase. Specifically, the insulator 33 is disposed in six slots 311 where the second coils of different phases are to be disposed in step S34.

FIG. 30 is a diagram illustrating an insertion step of first coils in step S33.

In step S33, as illustrated in FIG. 30, first coils of each phase are attached to the stator core 31 by the inserter 9. Specifically, in the coil ends 32a, the first coils of each phase are arranged at regular intervals in the circumferential direction, and are disposed in the outer layers or the inner layers of the slots 311 by distributed winding. Consequently, the first coil of each coil group of each phase is disposed in the intermediate region of the coil ends 32a. In this case, the first coils U1 of the U-phase coils 32U, the first coils V1 of the V-phase coils 32V, and the first coils W1 of the W-phase coils 32W are disposed in the outer layers or the inner layers of the slots 311 by distributed winding. The first coils of each phase may be disposed in the outer layers and the inner layers of the slots 311.

FIG. 31 is a diagram illustrating an insertion step of second coils in step S34.

In step S34, as illustrated in FIG. 31, second coils of each phase are attached to the stator core 31 by the inserter 9. Specifically, the second coils of each phase are disposed at regular intervals in the circumferential direction in the coil ends 32a, and disposed in the inner layers of the slots 311 of the stator core 31 by distributed winding. That is, the second coils U2 of the U-phase coils 32U, the second coils V2 of the V-phase coils 32V, and the second coils W2 of the W-phase coils 32W are disposed in the inner layers of the slots 311 by distributed winding. Consequently, the second coil of each coil group of each phase is disposed in the inner region of the coil ends 32a.

Specifically, a part of the second coils U2 of the U-phase coils 32U is disposed in the inner layers of the slots 311 in which a part of the third coils U3 is disposed. That is, the second coils U2 are disposed in the stator core 31 at two-slot pitch such that a part of the third coils U3 and a part of the second coils U2 are disposed in the same slots 311.

A part of the second coils V2 of the V-phase coils 32V is disposed in the inner layers of the slots 311 in which a part of the third coils V3 is disposed. That is, the second coils V2 are disposed in the stator core 31 at two-slot pitch such that a part of the third coils V3 and a part of the second coils V2 are disposed in the same slots 311.

A part of the second coils W2 of the W-phase coils 32W is disposed in the inner layers of the slots 311 in which a part of the third coils W3 is disposed. That is, the second coils W2 are disposed in the stator core 31 at two-slot pitch such that a part of the third coils W3 and a part of the second coils W2 are disposed in the same slots 311.

As described above, in steps S31 to S34, the first coils are disposed in the stator core 31 at two-slot pitch by distributed winding, the second coils are disposed in the stator core 31 at two-slot pitch by distributed winding, and the third coils are disposed in the stator core 31 at two-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S35, the U-phase coils 32U, the V-phase coils 32V, and the W-phase coils 32W are connected to one another. Thereafter, the shape of the connected three-phase coils 32 are appropriately adjusted. Consequently, the stator 3 illustrated in FIG. 24 is obtained.

### <Advantages of Stator 3 in Third Embodiment>

The stator 3 in the third embodiment has the advantages described in the first embodiment. The electric motor 1 according to the third embodiment has the advantages described in the first embodiment.

In addition, in the third embodiment, the second coil of each coil group of each phase is disposed in the inner region, and the third coil of each coil group of each phase is disposed in the outer region in the coil ends 32a. Accordingly, the contact area of the first coils in contact with coils of another phase is large. Thus, the first coils may be fixed together with coils of another phase adjacent to the first coils by the cord 34. In this case, it is possible to reduce vibrations in the electric motor 1 caused by an electromagnetic force generated between coils when current is supplied to the three-phase coils 32. As a result, noise in the electric motor 1 can be reduced.

Further, vanish may be applied to the three-phase coils 32. In this case, in the coil ends 32a, since the contact area of the first coils in contact with the coils of another phase is large, the entire three-phase coils 32 can be more firmly fixed, and thus vibrations in the electric motor 1 can be reduced. As a result, noise in the electric motor 1 can be reduced.

With the method for fabricating the stator 3 according to this embodiment, the stator 3 having the advantages described in this embodiment can be fabricated.

The method for fabricating the stator 3 in this embodiment has the advantages described in the first embodiment.

In addition, in the method for fabricating the stator 3 in this embodiment, the third coils are disposed in the outer region, and then the first coils are disposed in the inner region. In a case where the number of turns of each third coil is smaller than the number of turns of each first coil, the volume of each third coil is smaller than the volume of each first coil. In this case, the shape of the third coils can be easily adjusted, and thus, the third coils can be disposed in the stator core 31 beforehand in consideration of the region where the first coils are disposed. As a result, after the third coils are disposed in the stator core 31, the first coils and the second coils can be easily disposed in the stator core 31.

### Fourth Embodiment

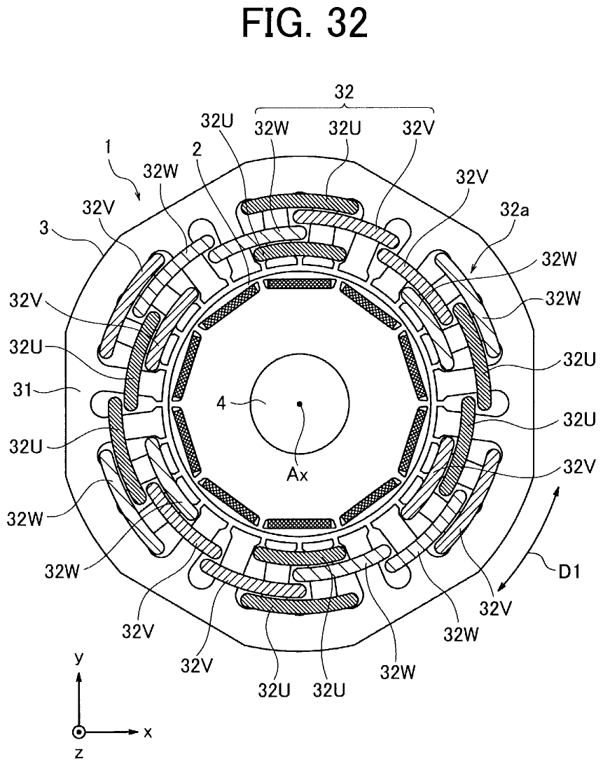

FIG. 32 is a plan view schematically illustrating a structure of an electric motor 1 according to a fourth embodiment.

In the fourth embodiment, arrangement of three-phase coils 32 is different from that described in the first embodiment. In the fourth embodiment, a part of the configuration different from that of the first embodiment will be described. Details not described in the fourth embodiment are the same as those in the first embodiment.

### <Stator 3>

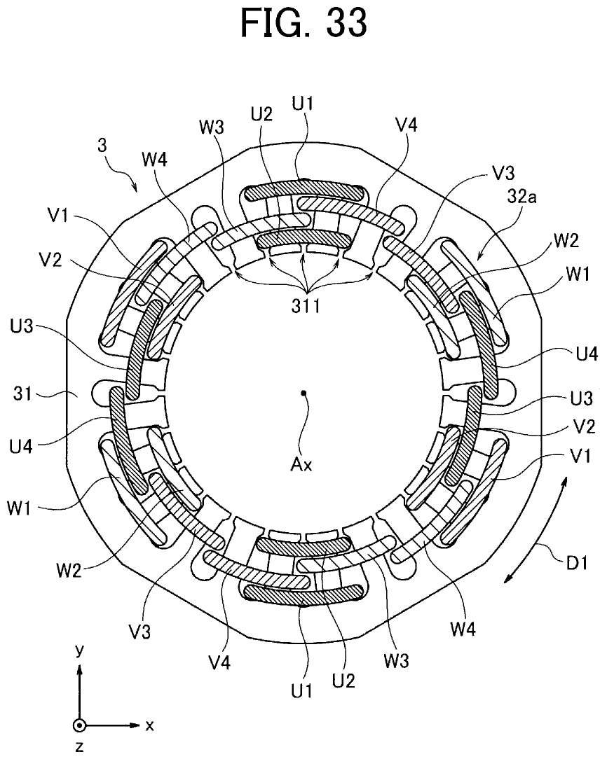

FIG. 33 is a plan view schematically illustrating a structure of a stator 3 according to the fourth embodiment.

In the example illustrated in FIG. 33, a stator core 31 includes 24 slots 311 in a manner similar to the first embodiment.

In the fourth embodiment, as illustrated in FIG. 32, the three-phase coils 32 include 8×n U-phase coils 32U, 8×n V-phase coils 32V, and 8×n W-phase coils 32W in the coil ends 32a.

In this embodiment, n=1. Thus, in the example illustrated in FIG. 32, in the coil ends 32a, the three-phase coils 32 include eight U-phase coils 32U, eight V-phase coils 32V, and eight W-phase coils 32W. It should be noted that the number of coils of each phase are not limited to eight. In this embodiment, the stator 3 has the structure illustrated in FIG. 33 in two coil ends 32a. It should be noted that the stator 3 only needs to have the structure illustrated in FIG. 33 in one of the two coil ends 32a.

When current flows in the three-phase coils 32, the three-phase coils 32 form 10×n magnetic poles. In this embodiment, n=1. Thus, in this embodiment, when current flows in the three-phase coils 32, the three-phase coils 32 form 10 magnetic poles.

As illustrated in FIG. 33, four U-phase coils 32U arranged in each coil end 32a will be referred to as a first coil U1, a second coil U2, a third coil U3, and a fourth coil U4, respectively. As illustrated in FIG. 33, four V-phase coils 32V in each coil end 32a will be referred to as a first coil V1, a second coil V2, a third coil V3, and a fourth coil V4, respectively. As illustrated in FIG. 33, four W-phase coils 32W in each coil end 32a will be referred to as a first coil W1, a second coil W2, a third coil W3, and a fourth coil W4, respectively. Each first coil U1, each second coil U2, each third coil U3, each fourth coil U4, each first coil V1, each second coil V2, each third coil V3, each fourth coil V4, each first coil W1, each second coil W2, each third coil W3, and each fourth coil W4 will also be referred to simply as coil, respectively.

### <U-Phase Coils 32U>

The 8×n U-phase coils 32U include 2×n sets of coil groups Ug each including a set of the first to fourth coils U1, U2, U3, and U4 in each coil end 32a. In the example illustrated in FIG. 33, the 8 U-phase coils 32U include 2 sets of coil groups Ug each including a set of the first to fourth coils U1, U2, U3, and U4 in each coil end 32a. In other words, the eight U-phase coils 32U include two sets of coil groups Ug, each coil group Ug of the eight U-phase coils 32U includes the first coil U1, the second coil U2, the third coil U3, and the fourth coil U4 in each coil end 32a.

In each coil end 32a, 2×n sets of coil groups Ug of the eight U-phase coils 32U are arranged at regular intervals in the circumferential direction of the stator 3. In each coil end 32a, the first coil U1 and the second coil U2 of each coil group Ug are disposed with at least one coil of another phase sandwiched therebetween. In each coil end 32a, the second coil U2 of each coil group Ug is disposed inward from the first coil U1. In each coil end 32a, the second coil U2, the third coil U3, and the fourth coil U4 of each coil group Ug are arranged in this order in the circumferential direction of the stator 3. The first coils U1 are disposed in the stator core 31 at two-slot pitch, the second coils U2 are disposed in the stator core 31 at two-slot pitch, and the third coils U3 are disposed in the stator core 31 at two-slot pitch, and the fourth coils U4 are disposed in the stator core 31 at two-slot pitch. In the coil ends 32a, the third coil U3 of each coil group Ug is adjacent to the first coil U1 and the second coil U2 with two slots 311 sandwiched therebetween.

The first coil U1, the second coil U2, the third coil U3, and the fourth coil U4 of each coil group Ug are connected in series.

### <V-phase Coils 32V>

The 8×n V-phase coils 32V include 2×n sets of coil groups Vg each including a set of the first to fourth coils V1, V2, V3, and V4 in each coil end 32a. In the example illustrated in FIG. 33, the 8×n V-phase coils 32V include 2 sets of coil groups Vg each including a set of the first to fourth coils V1, V2, V3, and V4 in each coil end 32a. In other words, the eight V-phase coils 32V include two sets of coil groups Vg, and each coil group Vg of the eight V-phase coils 32V includes the first coil V1, the second coil V2, the third coil V3, and the fourth coil V4 in each coil end 32a.

In each coil end 32a, 2×n sets of coil groups Vg of the eight V-phase coils 32V are arranged at regular intervals in the circumferential direction of the stator 3. In each coil end 32a, the first coil V1 and the second coil V2 of each coil group Vg are disposed with at least one coil of another phase sandwiched therebetween. In each coil end 32a, the second coil V2 of each coil group Vg is disposed inward from the first coil V1. In each coil end 32a, the second coil V2, the third coil V3, and the fourth coil V4 of each coil group Vg are arranged in that order in the circumferential direction of the stator 3. The first coils V1 are disposed in the stator core 31 at two-slot pitch, the second coils V2 are disposed in the stator core 31 at two-slot pitch, the third coils V3 are disposed in the stator core 31 at two-slot pitch, and the fourth coils V4 are disposed in the stator core 31 at two-slot pitch. In the coil ends 32a, the third coil V3 of each coil group Vg is adjacent to the first coil V1 and the second coil V2 with two slots 311 sandwiched therebetween.

The first coil V1, the second coil V2, the third coil V3, and the fourth coil V4 of each coil group Vg are connected in series.

### <W-phase Coils 32W>

The 8×n W-phase coils 32W include 2×n sets of coil groups Wg each including a set of the first to fourth coils W1, W2, W3, and W4 in each coil end 32a. In the example illustrated in FIG. 33, the 8×n W-phase coils 32W include 2 sets of coil groups Wg each including a set of the first to fourth coils W1, W2, W3, and W4 in each coil end 32a. In other words, the eight W-phase coils 32W include two sets of coil groups Wg, and each coil group Wg of the eight W-phase coils 32W includes the first coil W1, the second coil W2, the third coil W3, and the fourth coil W4 in each coil end 32a.

In each coil end 32a, 2×n sets of coil groups Wg of the eight W-phase coils 32W are arranged at regular intervals in the circumferential direction of the stator 3. In each coil end 32a, the first coil W1 and the second coil W2 of each coil group Wg are disposed with at least one coil of another phase sandwiched therebetween. In each coil end 32a, the second coil W2 of each coil group Wg is disposed inward from the first coil W1. In each coil end 32a, the second coil W2, the third coil W3, and the fourth coil W4 of each coil group Wg are arranged in that order in the circumferential direction of the stator 3. The first coils W1 are disposed in the stator core 31 at two-slot pitch, the second coils W2 are disposed in the stator core 31 at two-slot pitch, the third coils W3 are disposed in the stator core 31 at two-slot pitch, and the fourth coils W4 are disposed in the stator core 31 at two-slot pitch. In the coil ends 32a, the third coil W3 of each coil group Wg is adjacent to the first coil W1 and the second coil W2 with two slots 311 sandwiched therebetween.

The first coil W1, the second coil W2, the third coil W3, and the fourth coil W4 of each coil group Wg are connected in series.

<Arrangement of Coils in Coil End 32a>

Arrangement of the three-phase coils 32 in the coil ends 32a will be specifically described below. In the coil ends 32a of the three-phase coils 32, a region where the first to fourth coils of each coil group are disposed is divided into an inner region, a first intermediate region, a second intermediate region, and an outer region. The inner region is a region closest to the center of the stator core 31. The outer region is a region farthest from the center of the stator core 31. The first intermediate region and the second intermediate region are regions between the inner region and the outer region. Specifically, the first intermediate region is a region located outward from the inner region in the xy plane, the second intermediate region is a region located outward from the first intermediate region in the xy plane, and the outer region is a region located outward from the second intermediate region in the xy plane. Each of the inner region, the first intermediate region, the second intermediate region, and the outer region is a region extending in the circumferential direction.

In this embodiment, in the coil ends 32a, the first coil of each coil group is disposed in the intermediate region, the second coil is disposed in the inner region, the third coil is disposed in the first intermediate region, and the fourth coil is disposed in the second intermediate region.

In each coil end 32a, the first coil and the second coil of each coil group are disposed with at least one coil of another phase sandwiched therebetween. In the example illustrated in FIG. 33, the first coil and the second coil of each coil group are disposed with two coils of another phase sandwiched therebetween. For example, in the coil ends 32a, the first coil U1 and the second coil U2 of each coil group Ug are disposed with the fourth coil V4 of the V phase and the third coil W3 of the W phase sandwiched therebetween.

In this embodiment, in the coil ends 32a of each phase, the second coil, the third coil, and the fourth coil of each coil group are arranged counterclockwise in that order. Alternatively, in the coil ends 32a of each phase, the second coil, the third coil, and the fourth coil constituting each coil group may be arranged clockwise in that order.

### <Summary of Arrangement of Coils in Slots 311>

The first coils of the coil groups of each phase are disposed in the stator core 31 at two-slot pitch. The second coils of the coil groups of each phase are disposed in the stator core 31 at two-slot pitch. The third coils of the coil groups of each phase are disposed in the stator core 31 at two-slot pitch. The fourth coils of the coil groups of each phase are disposed in the stator core 31 at two-slot pitch. The fourth coil of each coil group of each phase is connected in series to the adjacent third coil.

The first coil of each coil group of each phase is disposed in the outer layer of the slot 311. The first coil and the second coil of each coil group of each phase are disposed in the same two slots 311.

The second coil of each coil group of each phase is disposed in the inner layer of the slot 311 where the first coil is disposed.

The third coil of each coil group of each phase is disposed in the inner layer of the slot 311. In each coil group of each phase, a part of the third coil is disposed in the slot 311 where a part of the fourth coil is disposed.

The fourth coil of each coil group of each phase is disposed in the outer layer of the slot 311. In each coil group of each phase, a part of the fourth coil is disposed in the slot 311 where a part of the third coil is disposed.

### <Number of Turns of Coil in Fourth Embodiment>

In each coil group of each phase, the sum of the number of turns of the first coil and the number of turns of the second coil is preferably equal to the number of turns of the third coil and the number of turns of the fourth coil.

### <Method for Fabricating Stator 3 in Fourth Embodiment>

An example of a method for fabricating the stator 3 in the fourth embodiment will be described.

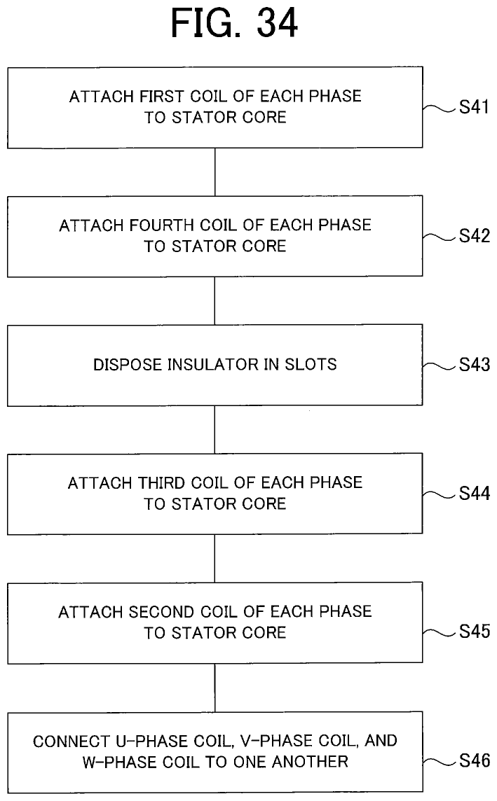

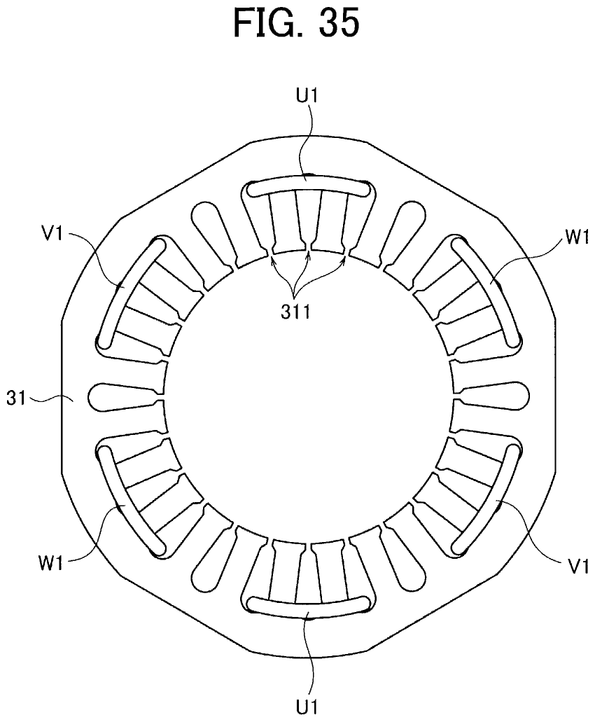

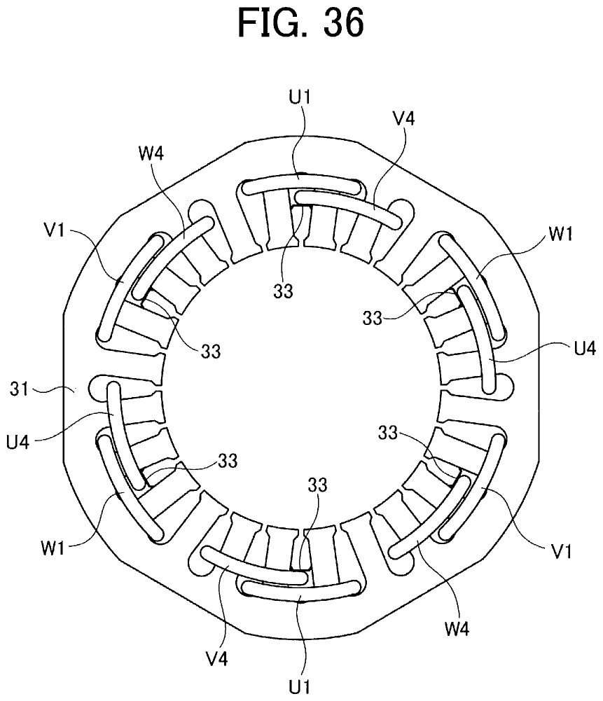

FIG. 34 is a flowchart showing an example of a process of fabricating the stator 3 according to the fourth embodiment.

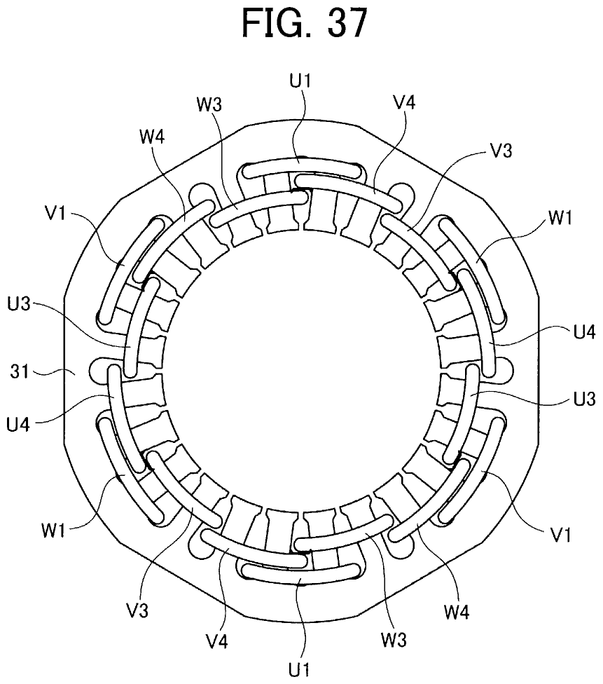

FIG. 35 is a diagram illustrating an insertion step of first coils in step S41.

In step S41, as shown in FIG. 35, first coils of each phase are attached to a previously prepared stator core 31 by an inserter 9. Specifically, in the coil ends 32a, the first coils of each phase are arranged at regular intervals in the circumferential direction, and are disposed in the outer layers of the slots 311 by distributed winding. That is, the first coils U1 of the U-phase coils 32U, the first coils V1 of the V-phase coils 32V, and the first coils W1 of the W-phase coils 32W are disposed in the outer layers of the slots 311 by distributed winding. Consequently, the first coil of each coil group of each phase is disposed in the outer region of the coil ends 32a.

FIG. 36 is a diagram illustrating an insertion step of fourth coils in step S42.

In step S42, as shown in FIG. 36, fourth coils of each phase are attached to the previously prepared stator core 31 by the inserter 9. Specifically, in the coil ends 32a, the fourth coils of each phase are arranged at regular intervals in the circumferential direction, and are disposed in the outer layers of the slots 311 by distributed winding. That is, the fourth coils U4 of the U-phase coils 32U, the fourth coils V4 of the V-phase coils 32V, and the fourth coils W4 of the W-phase coils 32W are disposed in the outer layers of the slots 311 by distributed winding. In this case, in each coil group, the fourth coil is disposed in the stator core 31 at two-slot pitch such that a part of the fourth coil and a part of the third coil are disposed in the same slot 311. Consequently, the fourth coil of each coil group of each phase is disposed in the second intermediate region of the coil ends 32a.

In step S43, the insulator 33 is disposed in the slots 311 where the fourth coils of each phase are disposed to insulate the fourth coils of each phase. Specifically, the insulator 33 is disposed in six slots 311 where the third coils of different phases are to be disposed in the next step S.

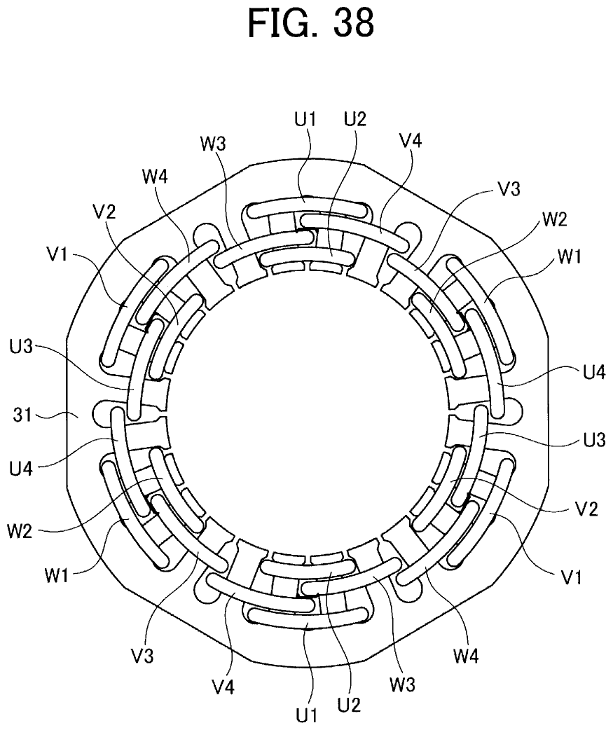

FIG. 37 is a diagram illustrating an insertion step of third coils in step S44.

In step S44, as shown in FIG. 37, third coils of each phase are attached to the previously prepared stator core 31 by the inserter 9. Specifically, in the coil ends 32a, the third coils of each phase are arranged at regular intervals in the circumferential direction, and are disposed in the inner layers of the slots 311 by distributed winding. That is, the third coils U3 of the U-phase coils 32U, the third coils V3 of the V-phase coils 32V, and the third coils W3 of the W-phase coils 32W are disposed in the inner layers of the slots 311 by distributed winding. Consequently, the third coil of each coil group of each phase is disposed in the first intermediate region of the coil ends 32a.

FIG. 38 is a diagram illustrating an insertion step of second coils in step S45.

In step S45, as shown in FIG. 38, second coils of each phase are attached to the previously prepared stator core 31 by the inserter 9. Specifically, second coils of each phase are disposed at regular intervals in the circumferential direction in the coil ends 32a, and disposed by distributed winding in the inner layers of the slots 311 where the first coils are disposed. That is, the second coils U2 of the U-phase coils 32U, the second coils V2 of the V-phase coils 32V, and the second coils W2 of the W-phase coils 32W are disposed in the inner layers of the slots 311 by distributed winding. In this case, the second coils are disposed at two-slot pitch in the slots 311 where the first coils are disposed such that the first coil and the second coil of each coil group of each phase are disposed with a coil of another phase sandwiched therebetween in the coil ends 32a.

Consequently, the second coil of each coil group of each phase is disposed inward from the first coil in the coil ends 32a. That is, the second coil of each coil group of each phase is disposed in the inner region of the coil ends 32a.

As described above, in steps S41 to S45, the first coils are disposed in the stator core 31 at two-slot pitch by distributed winding, the second coils are disposed in the stator core 31 at two-slot pitch by distributed winding, the third coils are disposed in the stator core 31 at two-slot pitch by distributed winding, and the fourth coils are disposed in the stator core 31 at two-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S46, the U-phase coils 32U, the V-phase coils 32V, and the W-phase coils 32W are connected to one another. Thereafter, the shape of the connected three-phase coils 32 are appropriately adjusted. Consequently, the stator 3 illustrated in FIG. 33 is obtained.

### <Advantages of Stator 3 in Fourth Embodiment>

The stator 3 in the fourth embodiment has the advantages described in the first embodiment. The electric motor 1 according to the fourth embodiment has the advantages described in the first embodiment.

In addition, in the fourth embodiment, the first coil of each coil group of each phase is disposed in the outer region, and the second coil of each coil group of each phase is disposed in the inner region. Thus, as compared to the first embodiment, the size of the coil ends 32a can be reduced in the axial direction.

Further, vanish may be applied to the three-phase coils 32. In this case, in the coil ends 32a, since the contact area between coils of different phases is large, the entire three-phase coils 32 can be more firmly fixed, and thus vibrations in the electric motor 1 can be reduced. As a result, noise in the electric motor 1 can be reduced.

With the method for fabricating the stator 3 according to this embodiment, the stator 3 having the advantages described in this embodiment can be fabricated.

In addition, the method for fabricating the stator 3 in this embodiment has the advantages described in the first embodiment.

Further, in the method for fabricating the stator 3 in this embodiment, the first coils of each phase and the second coils of each phase are disposed in the stator core 31 in two steps. The number of turns of each first coil in the fourth embodiment is smaller than the number of turns of each first coil in each of the first to third embodiments, and the number of turns of each second coil in the fourth embodiment is smaller than the number of turns of each first coil in each of the first to third embodiments. Thus, as compared to the second embodiment, for example, coils (specifically second coils) can be easily disposed in the inner region, and the size of the coil ends 32a can be reduced.

### Fifth Embodiment

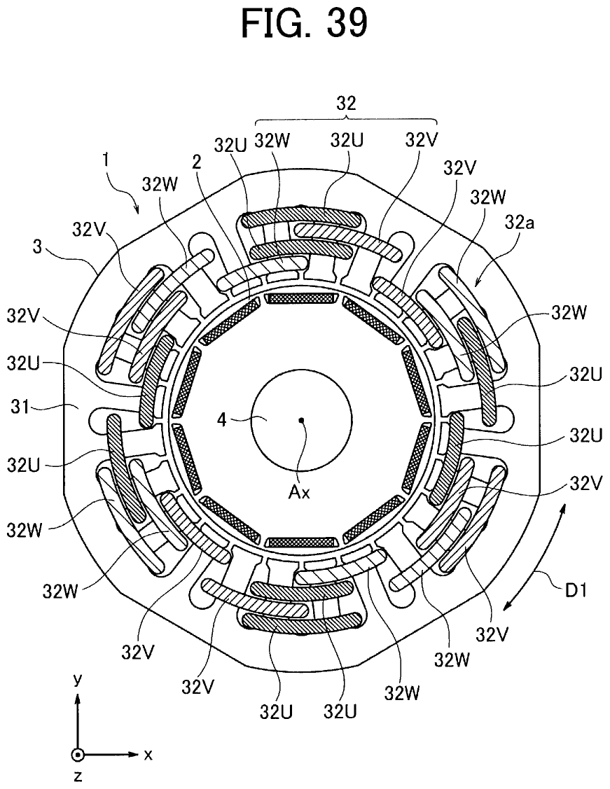

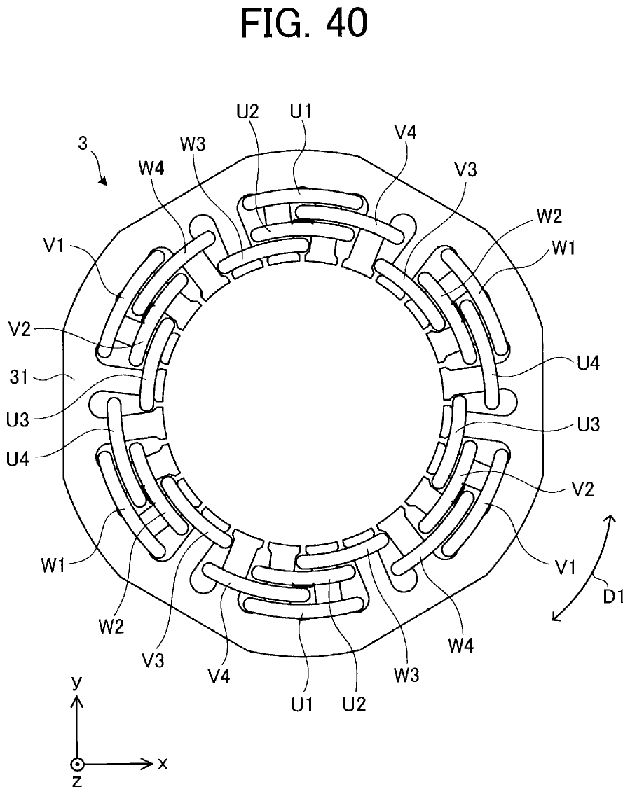

FIG. 39 is a plan view schematically illustrating a structure of an electric motor 1 according to a fifth embodiment.

In the fifth embodiment, arrangement of three-phase coils 32 is different from that described in the fourth embodiment. In the fifth embodiment, a part of the configuration different from that of the fourth embodiment will be described. Details not described in the fifth embodiment are the same as those in the first or fourth embodiment.

### <Stator 3>

FIG. 40 is a plan view schematically illustrating a structure of a stator 3 according to the fifth embodiment.

In the example illustrated in FIGS. 39 and 40, a stator core 31 includes 24 slots 311 in a manner similar to the fourth embodiment.

<Arrangement of Coils in Coil End 32a>

In this embodiment, in the coil ends 32a, the first coil of each coil group is disposed in the outer region, the second coil is disposed in the first intermediate region, the third coil is disposed in the inner region, and the fourth coil is disposed in the second intermediate region.

### <Summary of Arrangement of Coils in Slots 311>

Arrangement of coils in slots is the same as that in the fourth embodiment.

### <Method for Fabricating Stator 3 in Fifth Embodiment>

An example of a method for fabricating the stator 3 in the fifth embodiment will be described.

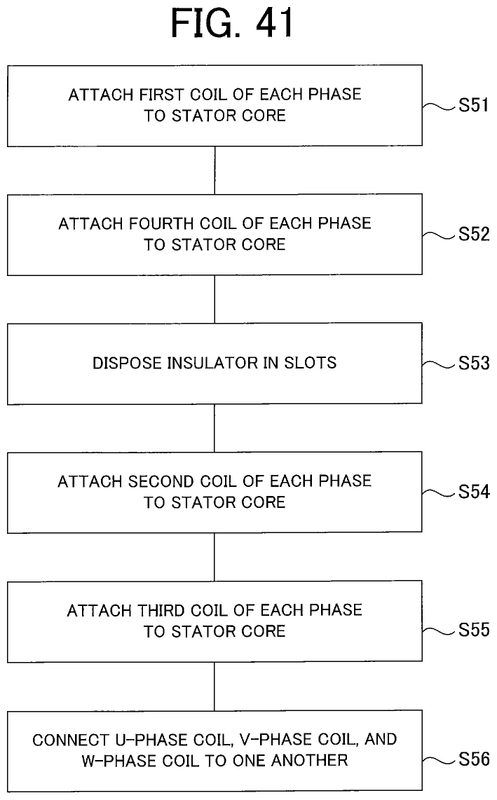

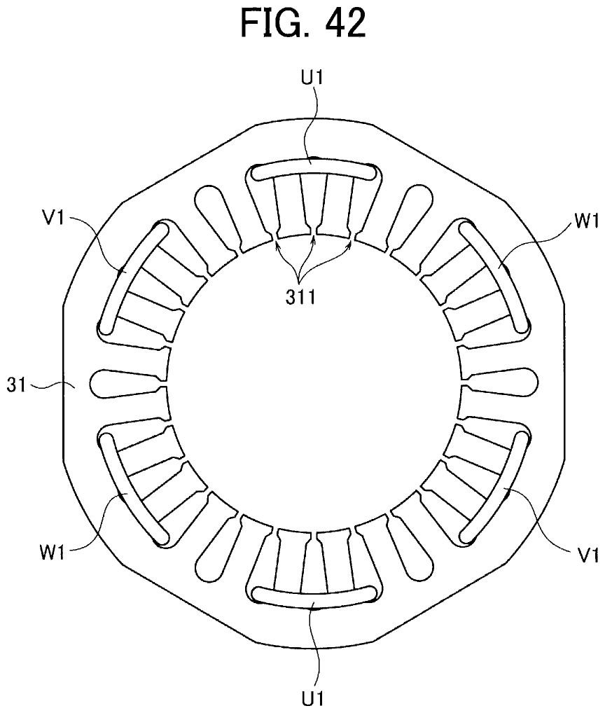

FIG. 41 is a flowchart showing an example of a process of fabricating the stator 3 according to the fifth embodiment.

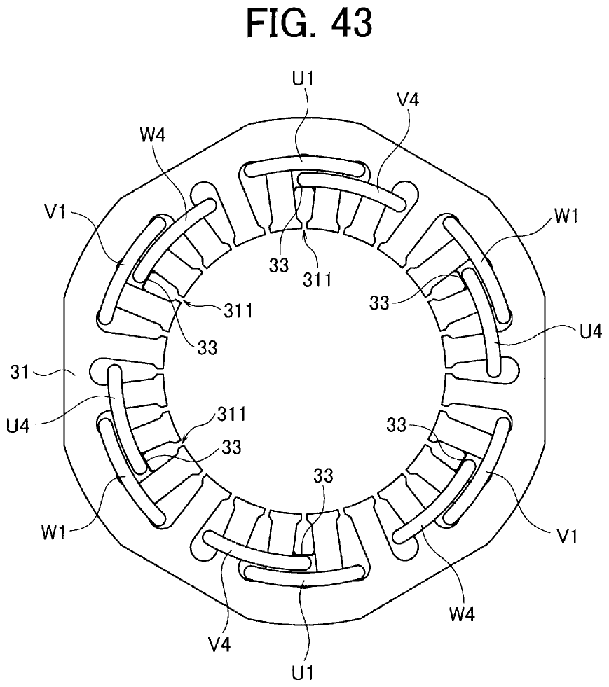

FIG. 42 is a diagram illustrating an insertion step of first coils in step S51.

In step S51, as shown in FIG. 42, first coils of each phase are attached to a previously prepared stator core 31 by an inserter 9. Specifically, in the coil ends 32a, the first coils of each phase are arranged at regular intervals in the circumferential direction, and are disposed in the outer layers of the slots 311 by distributed winding. That is, the first coils U1 of the U-phase coils 32U, the first coils V1 of the V-phase coils 32V, and the first coils W1 of the W-phase coils 32W are disposed in the outer layers of the slots 311 by distributed winding. Consequently, the first coil of each coil group of each phase is disposed in the outer region of the coil ends 32a.

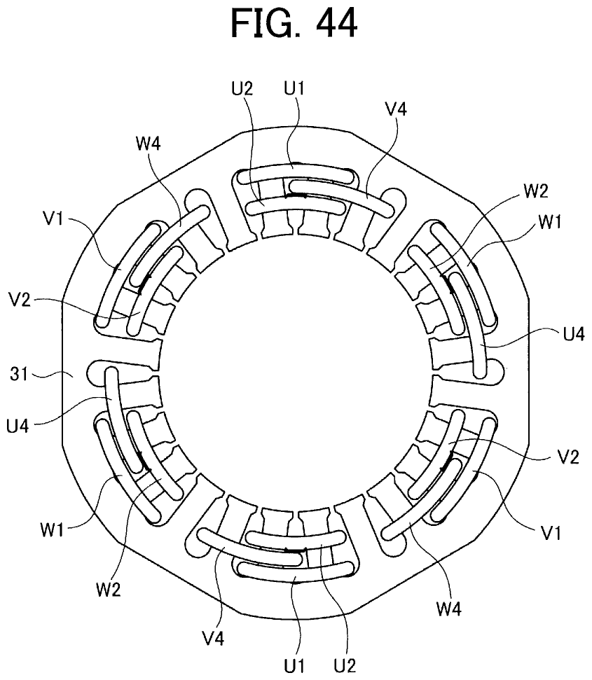

FIG. 43 is a diagram illustrating an insertion step of fourth coils in step S52.

In step S52 as shown in FIG. 43, fourth coils of each phase are attached to the previously prepared stator core 31 by the inserter 9. Specifically, in the coil ends 32a, the fourth coils of each phase are arranged at regular intervals in the circumferential direction, and are disposed in the outer layers of the slots 311 by distributed winding. That is, the fourth coils U4 of the U-phase coils 32U, the fourth coils V4 of the V-phase coils 32V, and the fourth coils W4 of the W-phase coils 32W are disposed in the outer layers of the slots 311 by distributed winding. In this case, in each coil group, the fourth coil is disposed in the stator core 31 at two-slot pitch such that a part of the fourth coil and a part of the third coil are disposed in the same slot 311. Consequently, the fourth coil of each coil group of each phase is disposed in the second intermediate region of the coil ends 32a.

In step S53, the insulator 33 is disposed in the slots 311 where the fourth coils of each phase are disposed to insulate the fourth coils of each phase. Specifically, the insulator 33 is disposed in six slots 311 where the third coils of different phases are to be disposed in step S55.

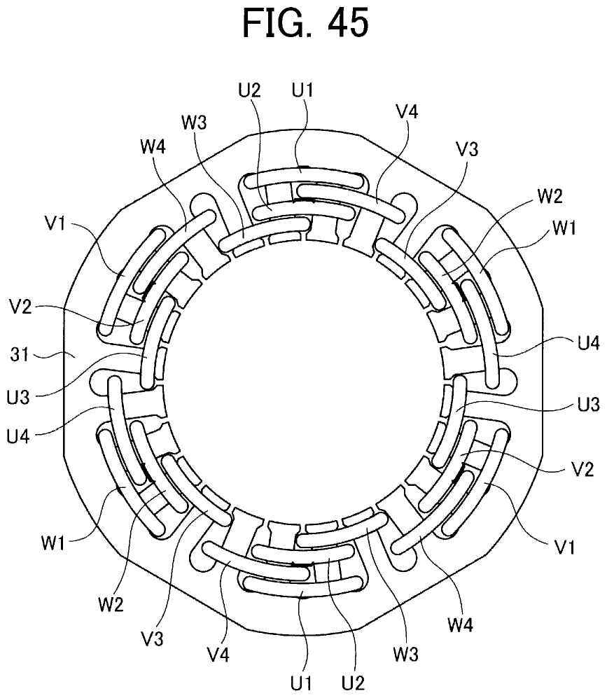

FIG. 44 is a diagram illustrating an insertion step of second coils in step S54.

In step S44, as shown in FIG. 44, second coils of each phase are attached to the previously prepared stator core 31 by the inserter 9. Specifically, in the coil ends 32a, second coils of each phase are disposed at regular intervals in the circumferential direction, and disposed by distributed winding in the inner layers of the slots 311 where the first coils are disposed. That is, the second coils U2 of the U-phase coils 32U, the second coils V2 of the V-phase coils 32V, and the second coils W2 of the W-phase coils 32W are disposed in the inner layers of the slots 311 by distributed winding. In this case, the second coils are disposed at two-slot pitch in the slots 311 where the first coils are disposed such that the first coil and the second coil of each coil group of each phase are disposed with a coil of another phase sandwiched therebetween in the coil ends 32a.

Consequently, the second coil of each coil group of each phase is disposed inward from the first coil in the coil ends 32a. That is, the second coil of each coil group of each phase is disposed in the first intermediate region of the coil ends 32a.

FIG. 45 is a diagram illustrating an insertion step of third coils in step S55.

In step S55, as shown in FIG. 45, third coils of each phase are attached to the previously prepared stator core 31 by the inserter 9. Specifically, in the coil ends 32a, the third coils of each phase are arranged at regular intervals in the circumferential direction, and are disposed in the inner layers of the slots 311 by distributed winding. That is, the third coils U3 of the U-phase coils 32U, the third coils V3 of the V-phase coils 32V, and the third coils W3 of the W-phase coils 32W are disposed in the inner layers of the slots 311 by distributed winding. In this case, in each coil group, the third coil is disposed in the stator core 31 at two-slot pitch such that a part of the fourth coil and a part of the third coil are disposed in the same slot 311. Consequently, the third coil of each coil group of each phase is disposed in the inner region of the coil ends 32a.

As described above, in steps S51 to S55, the first coils are disposed in the stator core 31 at two-slot pitch by distributed winding, the second coils are disposed in the stator core 31 at two-slot pitch by distributed winding, the third coils are disposed in the stator core 31 at two-slot pitch by distributed winding, and the fourth coils are disposed in the stator core 31 at two-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S56, the U-phase coils 32U, the V-phase coils 32V, and the W-phase coils 32W are connected to one another. Thereafter, the shape of the connected three-phase coils 32 are appropriately adjusted. Consequently, the stator 3 illustrated in FIG. 40 is obtained.

### <Advantages of Stator 3 in Fifth Embodiment>

The stator 3 in the fifth embodiment has the advantages described in the fourth embodiment. The electric motor 1 according to the fifth embodiment has the advantages described in the first embodiment.

In addition, in the fifth embodiment, the first coil of each coil group of each phase is disposed in the outer region, and the second coil of each coil group of each phase is disposed in the first intermediate region. Thus, as compared to the first embodiment, the size of the coil ends 32a can be reduced in the axial direction.

In the fifth embodiment, since the first coils of each phase are disposed in the outer region, the second coils, the third coils, and the fourth coils of each phase can be disposed in the same manner as wave winding. As a result, the size of the coil ends 32a can be reduced.

With the method for fabricating the stator 3 according to this embodiment, the stator 3 having the advantages described in this embodiment can be fabricated.

In addition, the method for fabricating the stator 3 in this embodiment has the advantages described in the fourth embodiment.

Further, in the method for fabricating the stator 3 in this embodiment, the first coils of each phase and the second coils of each phase are disposed in the stator core 31 in two steps. The number of turns of each first coil in the fifth embodiment is smaller than the number of turns of each first coil in each of the first to third embodiments, and the number of turns of each second coil in the fifth embodiment is smaller than the number of turns of each first coil in each of the first to third embodiments. Thus, as compared to the second embodiment, for example, coils (specifically second coils) can be easily disposed in the inner region, and the size of the coil ends 32a can be reduced.

In addition, in the method for fabricating the stator 3 in this embodiment, the fourth coil of each coil group of each phase is disposed in the second intermediate region, and the third coil of each coil group of each phase is disposed in the inner region. In each coil group, a part of the fourth coil and a part of the third coil are disposed in the same slot 311. Accordingly, since other coils are not disposed between these coils, each third coil can be easily disposed in the inner region.

### Sixth Embodiment

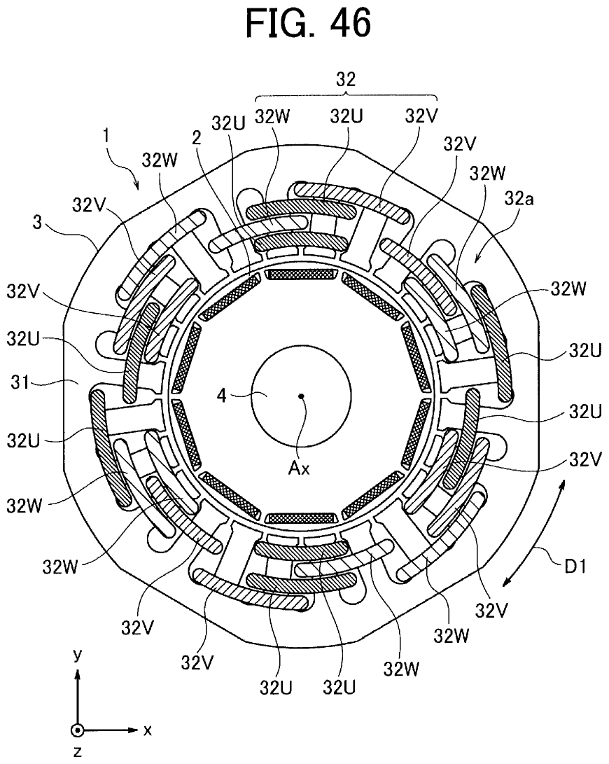

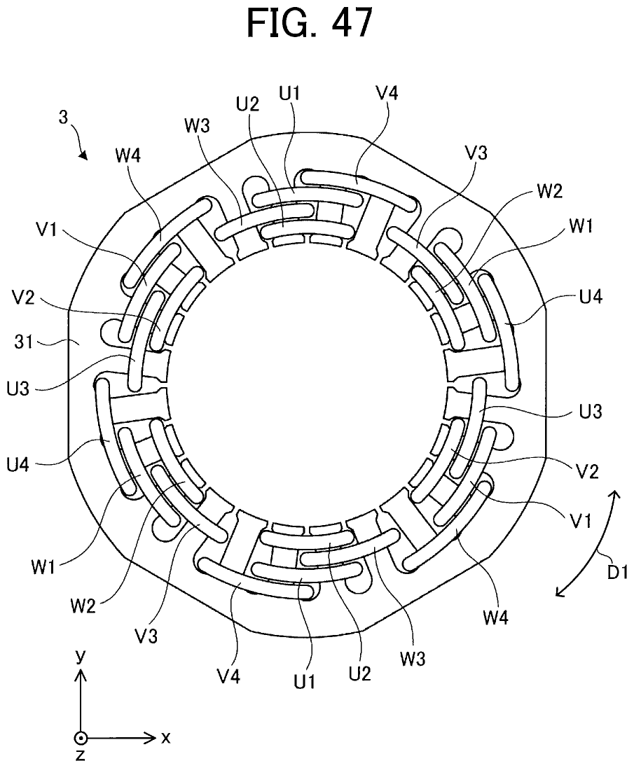

FIG. 46 is a plan view schematically illustrating a structure of an electric motor 1 according to a sixth embodiment.

In the sixth embodiment, arrangement of three-phase coils 32 is different from that described in the fourth embodiment. In the sixth embodiment, a part of the configuration different from that of the fourth embodiment will be described. Details not described in the sixth embodiment are the same as those in the first or fourth embodiment.

### <Stator 3>

FIG. 47 is a plan view schematically illustrating a structure of a stator 3 according to the sixth embodiment.

In the example illustrated in FIGS. 46 and 47, a stator core 31 includes 24 slots 311 in a manner similar to the fourth embodiment.

<Arrangement of Coils in Coil End 32a>

In this embodiment, in the coil ends 32a, the first coil of each coil group is disposed in the second intermediate region, the second coil is disposed in the inner region, the third coil is disposed in the first intermediate region, and the fourth coil is disposed in the outer region.

### <Summary of Arrangement of Coils in Slots 311>

Arrangement of coils in slots is the same as that in the fourth embodiment.

### <Method for Fabricating Stator 3 in Sixth Embodiment>

An example of a method for fabricating the stator 3 in the sixth embodiment will be described.

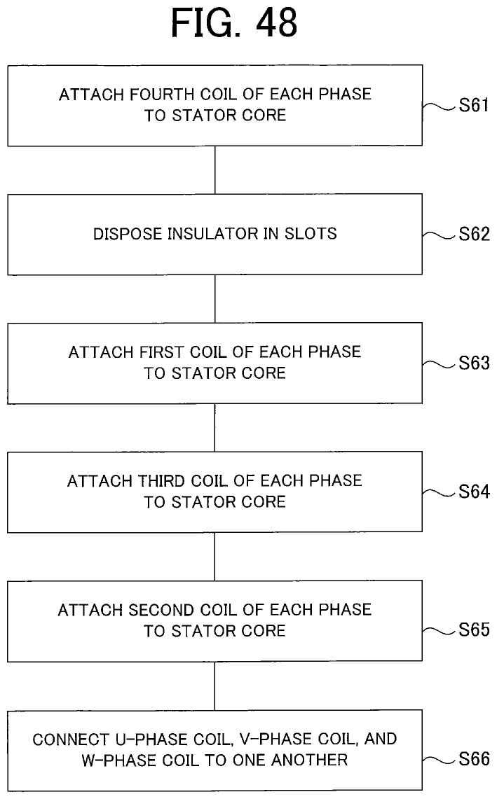

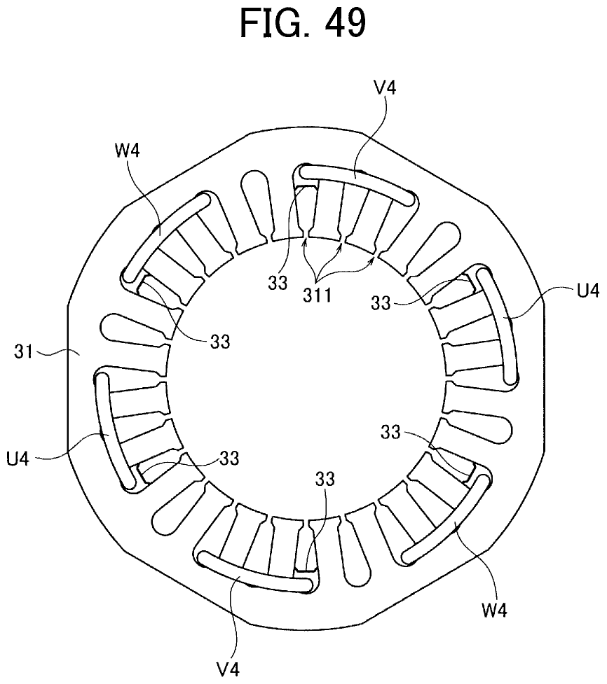

FIG. 48 is a flowchart showing an example of a process of fabricating the stator 3 according to the sixth embodiment.

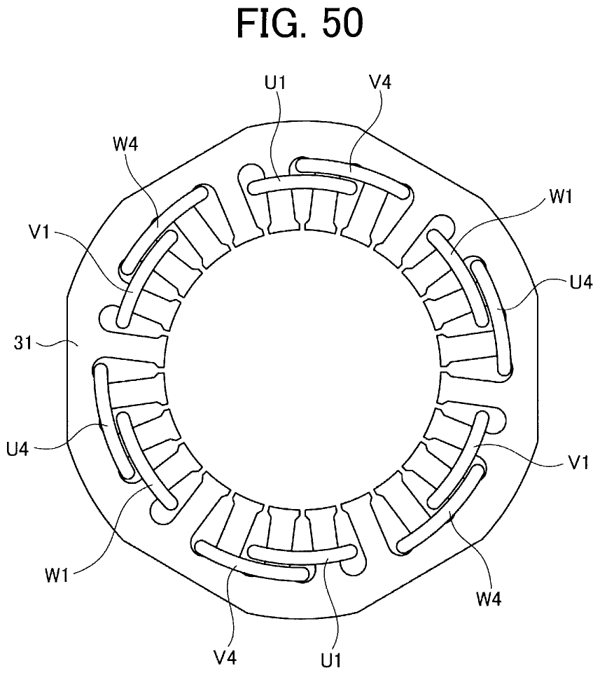

FIG. 49 is a diagram illustrating an insertion step of third coils in step S61.

In step S61, as shown in FIG. 49, fourth coils of each phase are attached to a previously prepared stator core 31 by an inserter 9. Specifically, the fourth coils of each phase are disposed at regular intervals in the circumferential direction in the coil ends 32a, and disposed in the outer layers of the slots 311 of the stator core 31 by distributed winding. That is, the fourth coils U4 of the U-phase coils 32U, the fourth coils V4 of the V-phase coils 32V, and the fourth coils W4 of the W-phase coils 32W are disposed in the outer layers of the slots 311 by distributed winding. Consequently, the fourth coil of each coil group of each phase is disposed in the outer region of the coil ends 32a.

In step S62, the insulator 33 is disposed in the slots 311 where the fourth coils of each phase are disposed to insulate the fourth coils of each phase. Specifically, the insulator 33 is disposed in six slots 311 where the third coils of different phases are to be disposed in step S64.

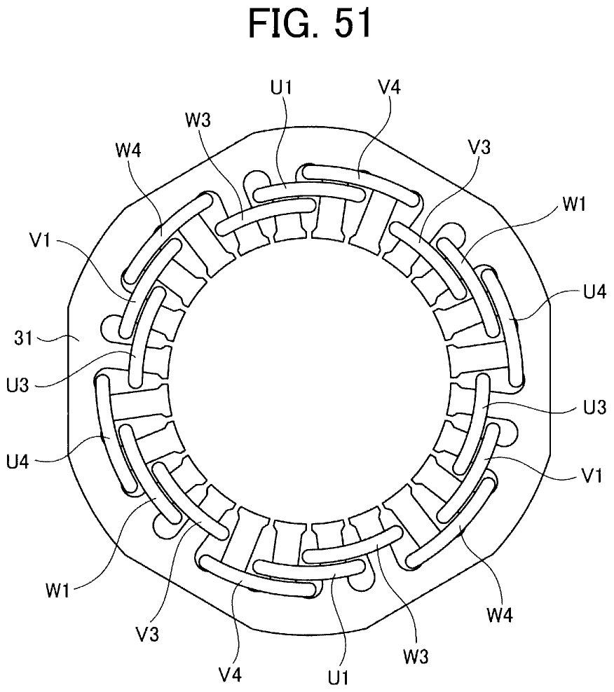

FIG. 50 is a diagram illustrating an insertion step of first coils in step S63.

In step S63, as shown in FIG. 50, first coils of each phase are attached to the previously prepared stator core 31 by the inserter 9. Specifically, in the coil ends 32a, the first coils of each phase are arranged at regular intervals in the circumferential direction, and are disposed in the outer layers of the slots 311 by distributed winding. Consequently, the first coil of each coil group of each phase is disposed in the second intermediate region of the coil ends 32a.

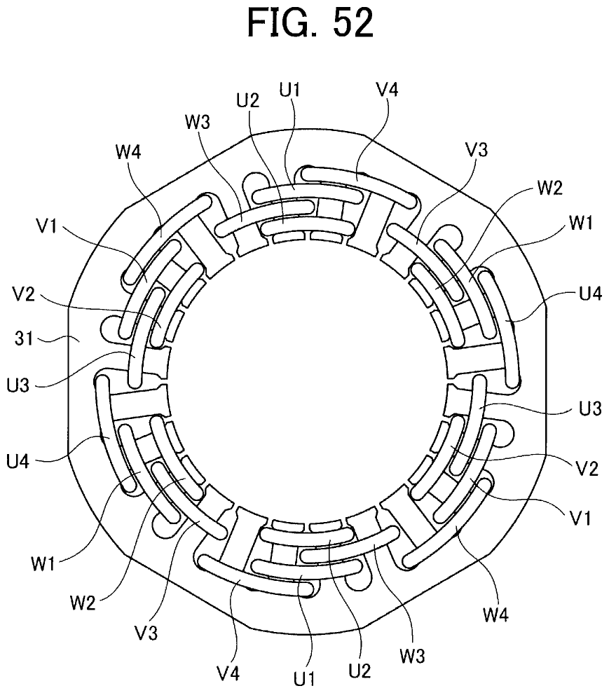

FIG. 51 is a diagram illustrating an insertion step of third coils in step S64.

In step S64, as shown in FIG. 51, third coils of each phase are attached to the previously prepared stator core 31 by the inserter 9. Specifically, the third coils of each phase are disposed at regular intervals in the circumferential direction in the coil ends 32a, and disposed in the inner layers of the slots 311 of the stator core 31 by distributed winding. That is, the third coils U3 of the U-phase coils 32U, the third coils V3 of the V-phase coils 32V, and the third coils W3 of the W-phase coils 32W are disposed in the inner layers of the slots 311 by distributed winding. In this case, in each coil group, the third coil is disposed in the stator core 31 at two-slot pitch such that a part of the fourth coil and a part of the third coil are disposed in the same slot 311. Consequently, the third coil of each coil group of each phase is disposed in the first intermediate region of the coil ends 32a.

FIG. 52 is a diagram illustrating an insertion step of second coils in step S65.

In step S65, as shown in FIG. 52, second coils of each phase are attached to the previously prepared stator core 31 by the inserter 9. Specifically, the second coils of each phase are disposed at regular intervals in the circumferential direction in the coil ends 32a, and disposed in the inner layers of the slots 311 of the stator core 31 by distributed winding. That is, the second coils U2 of the U-phase coils 32U, the second coils V2 of the V-phase coils 32V, and the second coils W2 of the W-phase coils 32W are disposed in the inner layers of the slots 311 by distributed winding. In this case, the second coils are disposed at two-slot pitch in the slots 311 where the first coils are disposed such that the first coil and the second coil of each coil group of each phase are disposed with a coil of another phase sandwiched therebetween in the coil ends 32a.

Consequently, the second coil of each coil group of each phase is disposed inward from the first coil in the coil ends 32a. That is, the second coil of each coil group of each phase is disposed in the inner region of the coil ends 32a.

As described above, in steps S61 to S65, the first coils are disposed in the stator core 31 at two-slot pitch by distributed winding, the second coils are disposed in the stator core 31 at two-slot pitch by distributed winding, the third coils are disposed in the stator core 31 at two-slot pitch by distributed winding, and the fourth coils are disposed in the stator core 31 at two-slot pitch by distributed winding. As a result, the three-phase coils 32 are attached to the stator core 31 by distributed winding such that the three-phase coils 32 have the arrangement described in this embodiment in the coil ends 32a of the three-phase coils 32 and the slots 311.

In step S66, the U-phase coils 32U, the V-phase coils 32V, and the W-phase coils 32W are connected to one another. Thereafter, the shape of the connected three-phase coils 32 are appropriately adjusted. Consequently, the stator 3 illustrated in FIG. 47 is obtained.

### <Advantages of Stator 3 in Sixth Embodiment>

The stator 3 in the sixth embodiment has the advantages described in the fourth embodiment. The electric motor 1 according to the sixth embodiment has the advantages described in the first embodiment.

In addition, in the sixth embodiment, the first coil of each coil group of each phase is disposed in the second intermediate region, and the second coil of each coil group of each phase is disposed in the inner region. Thus, as compared to the first embodiment, the size of the coil ends 32a can be reduced in the axial direction.

With the method for fabricating the stator 3 according to this embodiment, the stator 3 having the advantages described in this embodiment can be fabricated.

In addition, the method for fabricating the stator 3 in this embodiment has the advantages described in the fourth embodiment.

Further, in the method for fabricating the stator 3 in this embodiment, the first coils of each phase and the second coils of each phase are disposed in the stator core 31 in two steps. The number of turns of each first coil in the sixth embodiment is smaller than the number of turns of each first coil in each of the first to third embodiments, and the number of turns of each second coil in the sixth embodiment is smaller than the number of turns of each first coil in each of the first to third embodiments. Thus, as compared to the second embodiment, for example, coils (specifically second coils) can be easily disposed in the inner region, and the size of the coil ends 32a can be reduced.

In addition, in the method for fabricating the stator 3 in this embodiment, since coils of different phases are not present in the slot 311 where the insulator 33 is disposed, the insulator 33 can be easily disposed in the slot 311.

### Seventh Embodiment

A compressor 300 according to a seventh embodiment will be described.

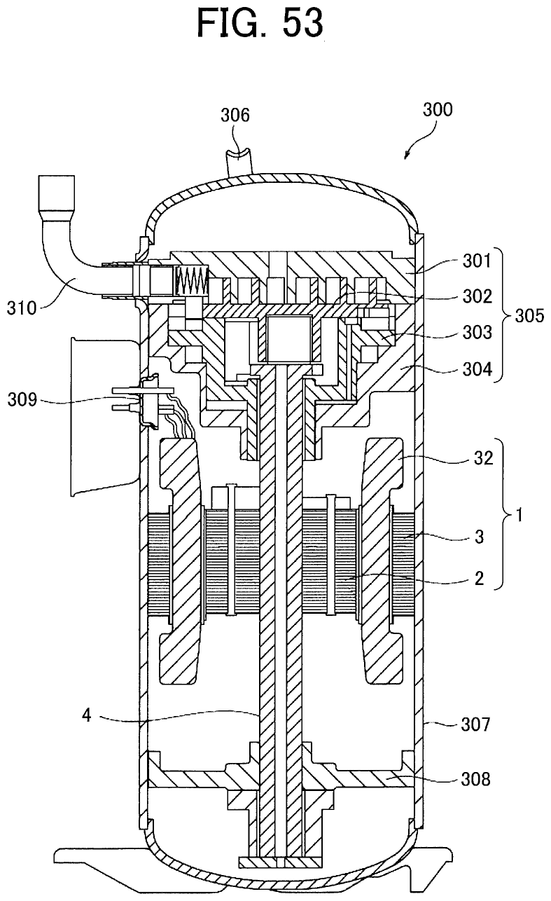

FIG. 53 is a cross-sectional view schematically illustrating a structure of the compressor 300.

The compressor 300 includes an electric motor 1 as an electric element, a closed container 307 as a housing, and a compression mechanism 305 as a compression element (also referred to as a compression device). In this embodiment, the compressor 300 is a scroll compressor. The compressor 300 is not limited to the scroll compressor. The compressor 300 may be a compressor except for the scroll compressor, such as a rotary compressor.

The electric motor 1 in the compressor 300 is the electric motor 1 described in one of the first to sixth embodiments (including the variation). The electric motor 1 drives the compression mechanism 305.

The compressor 300 includes a subframe 308 supporting a lower end (i.e., an end opposite to the compression mechanism 305) of a shaft 4.

The compression mechanism 305 is disposed inside the closed container 307. The compressor mechanism 305 includes a fixed scroll 301 having a spiral portion, a swing scroll 302 having a spiral portion forming a compression chamber between the spiral portion of the swing scroll 302 and the spiral portion of the fixed scroll 301, a compliance frame 303 holding an upper end of the shaft 4, and a guide frame 304 fixed to the closed container 307 and holding the compliance frame 303.

A suction pipe 310 penetrating the closed container 307 is press fitted in the fixed scroll 301. The closed container 307 is provided with a discharge pipe 306 that discharges a high-pressure refrigerant gas discharged from the fixed scroll 301, to the outside. The discharge pipe 306 communicates with an opening provided between the compressor mechanism 305 of the closed container 307 and the electric motor 1.

The electric motor 1 is fixed to the closed container 307 by fitting the stator 3 in the closed container 307. The configuration of the electric motor 1 has been described above. To the closed container 307, a glass terminal 309 for supplying electric power to the electric motor 1 is fixed by welding.

When the electric motor 1 rotates, this rotation is transferred to the swing scroll 302, and the swing scroll 302 swings. When the swing scroll 302 swings, the volume of the compression chamber formed by the spiral portion of the swing scroll 302 and the spiral portion of the fixed scroll 301 changes. Then, a refrigerant gas is sucked through the suction pipe 310, compressed, and then discharged through the discharge pipe 306.

The compressor 300 includes the electric motor 1 described in one of the first to sixth embodiments, and thus, has the advantages described in the corresponding embodiment.

In addition, since the compressor 300 includes the electric motor 1 described in one of the first to sixth embodiments, performance of the compressor 300 can be improved.

### Eighth Embodiment

A refrigeration air conditioning apparatus 7 serving as an air conditioner and including the compressor 300 according to the seventh embodiment will be described.

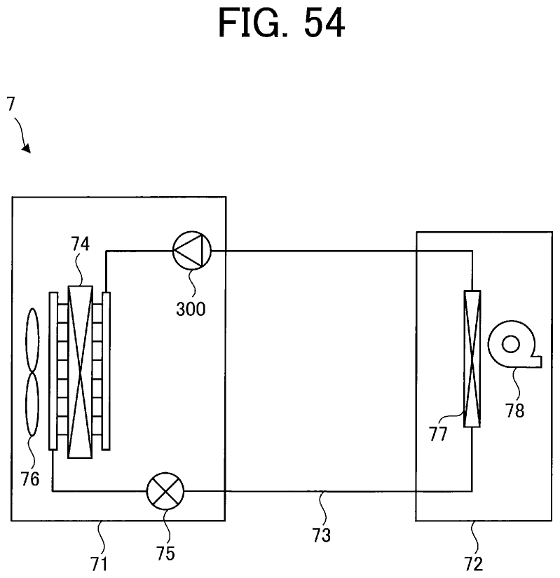

FIG. 54 is a diagram schematically illustrating a configuration of the refrigerating air conditioning apparatus 7 according to an eighth embodiment.

The refrigeration air conditioning apparatus 7 is capable of performing cooling and heating operations, for example. The refrigerant circuit diagram illustrated in FIG. 54 is an example of a refrigerant circuit diagram of an air conditioner capable of performing a cooling operation.

The refrigeration air conditioning apparatus 7 according to the eighth embodiment includes an outdoor unit 71, an indoor unit 72, and a refrigerant pipe 73 connecting the outdoor unit 71 and the indoor unit 72.

The outdoor unit 71 includes a compressor 300, a condenser 74 as a heat exchanger, a throttling device 75, and an outdoor air blower 76 (first air blower). The condenser 74 condenses refrigerant compressed by the compressor 300. The throttling device 75 decompresses the refrigerant condensed by the condenser 74 to thereby adjust a flow rate of the refrigerant. The throttling device 75 will be also referred to as a decompression device.

The indoor unit 72 includes an evaporator 77 as a heat exchanger, and an indoor air blower 78 (second air blower). The evaporator 77 evaporates the refrigerant decompressed by the throttling device 75 to thereby cool indoor air.

A basic operation of a cooling operation in the refrigeration air conditioning apparatus 7 will now be described. In the cooling operation, refrigerant is compressed by the compressor 300 and the compressed refrigerant flows into the condenser 74. The condenser 74 condenses the refrigerant, and the condensed refrigerant flows into the throttling device 75. The throttling device 75 decompresses the refrigerant, and the decompressed refrigerant flows into the evaporator 77. In the evaporator 77, the refrigerant evaporates, and the refrigerant (specifically a refrigerant gas) flows into the compressor 300 of the outdoor unit 71 again. When the air is sent to the condenser 74 by the outdoor air blower 76, heat moves between the refrigerant and the air. Similarly, when the air is sent to the evaporator 77 by the indoor air blower 78, heat moves between the refrigerant and the air.

The configuration and operation of the refrigeration air conditioning apparatus 7 described above are examples, and the present disclosure is not limited to the examples described above.

The refrigeration air conditioning apparatus 7 according to the eighth embodiment has the electric motor 1 described in one of the first to sixth embodiments, and thus, has the advantages described in the corresponding embodiment.

In addition, since the refrigeration air conditioning apparatus 7 according to the eighth embodiment includes the compressor 300 according to the seventh embodiment, performance of the refrigeration air conditioning apparatus 7 can be improved.

Features of the embodiments described above and features of variations thereof can be combined.

1. A stator comprising:
a stator core; and
three-phase coils attached to the stator core by distributed winding, wherein
the stator core includes 24×n (n is an integer equal to or larger than 1) slots,
the three-phase coils include 6×n U-phase coils, 6×n V-phase coils, and 6×n W-phase coils in a coil end of the three-phase coils and form 10×n magnetic poles,
the 6×n U-phase coils, the 6×n V-phase coils, and the 6×n W-phase coils each include 2×n sets of coil groups, the 2×n sets of coil groups each including a set of first to third coils,
the first to third coils are arranged in that order in a circumferential direction in the coil end,
the first coil is disposed in the stator core at two-slot pitch,
the second coil is disposed in the stator core at two-slot pitch,
the third coil is connected in series to the second coil and is disposed in the stator core at two-slot pitch, and
a part of the third coil is disposed in the slot in which a part of the second coil is disposed.

2. The stator according to claim 1, wherein
a region where the first to third coils are disposed in the coil end is divided into an inner region closest to a center of the stator core, an intermediate region located outward from the inner region, and an outer region located outward from the intermediate region, and
the first coil is disposed in the outer region.

3. The stator according to claim 1, wherein
a region where the first to third coils are disposed in the coil end is divided into an inner region closest to a center of the stator core, an intermediate region located outward from the inner region, and an outer region located outward from the intermediate region, and
the first coil is disposed in the inner region.

4. The stator according to claim 1, wherein
a region where the first to third coils are disposed in the coil end is divided into an inner region closest to a center of the stator core, an intermediate region located outward from the inner region, and an outer region located outward from the intermediate region, and
the first coil is disposed in the intermediate region.

5. A stator comprising:
a stator core; and
three-phase coils attached to the stator core by distributed winding, wherein
the stator core includes 24×n (n is an integer equal to or larger than 1) slots,
the three-phase coils include 8×n U-phase coils, 8×n V-phase coils, and 8×n W-phase coils in a coil end of the three-phase coils and form 10×n magnetic poles,
the 8×n U-phase coils, the 8×n V-phase coils, and the 8×n W-phase coils each include 2×n sets of coil groups, the 2×n sets of coil groups each including a set of first to fourth coils,
the second coil is disposed inward from the first coil in the coil end,
the second to fourth coils are arranged in that order in a circumferential direction,
the first coil is disposed in the stator core at two-slot pitch,
the second coil is disposed at two-slot pitch in the slot in which the first coil is disposed,
the third coil is disposed in the stator core at two-slot pitch,
the fourth coil is connected in series to the third coil and is disposed in the stator core at two-slot pitch,
a part of the fourth coil is disposed in the slot in which a part of the third coil is disposed, and
the first coil and the second coil are disposed with a coil of another phase sandwiched therebetween in the coil end.

6. The stator according to claim 5, wherein
a region where the first to fourth coils are disposed in the coil end is divided into an inner region closest to a center of the stator core, a first intermediate region located outward from the inner region, a second intermediate region located outward from the first intermediate region, and an outer region located outward from the second intermediate region,
the first coil is disposed in the outer region, and
the second coil is disposed in the inner region.

7. The stator according to claim 5, wherein
a region where the first to fourth coils are disposed in the coil end is divided into an inner region closest to a center of the stator core, a first intermediate region located outward from the inner region, a second intermediate region located outward from the first intermediate region, and an outer region located outward from the second intermediate region,
the first coil is disposed in the outer region, and
the third coil is disposed in the inner region.

8. The stator according to claim 5, wherein
a region where the first to fourth coils are disposed in the coil end is divided into an inner region closest to a center of the stator core, a first intermediate region located outward from the inner region, a second intermediate region located outward from the first intermediate region, and an outer region located outward from the second intermediate region,
the second coil is disposed in the inner region, and
the fourth coil is disposed in the outer region.

9. The stator according to claim 1, wherein the stator core is divided into a plurality of divided cores in the slot where the part of the second coil and the part of the third coil are disposed.

10. An electric motor comprising:
the stator according to claim 1; and
a rotor disposed inside the stator.

11. A compressor comprising:
a closed container;
a compression device disposed in the closed container; and
the electric motor according to claim 10 to drive the compression device.

12. An air conditioner comprising:
the compressor according to claim 11; and
a heat exchanger.

13. A method for fabricating a stator, the stator including a stator core and three-phase coils attached to the stator core by distributed winding,
the stator core including 24×n (n is an integer equal to or larger than 1) slots,
the three-phase coils including 6×n U-phase coils, 6×n V-phase coils, and 6×n W-phase coils in a coil end of the three-phase coils and forming 10×n magnetic poles,
the 6×n U-phase coils, the 6×n V-phase coils, and the 6×n W-phase coils each including 2×n sets of coil groups, the 2×n sets of coil groups each including a set of first to third coils,
the first to third coils being arranged in that order in a circumferential direction in the coil end, the method comprising:
disposing the first coil in the stator core at two-slot pitch;
disposing the third coil in the stator core at two-slot pitch; and
disposing the second coil in the stator core at two-slot pitch such that a part of the third coil and a part of the second coil are disposed in an identical slot.

14. The method for fabricating the stator according to claim 13, wherein
a region where the first to third coils are disposed in the coil end is divided into an inner region closest to a center of the stator core, an intermediate region located outward from the inner region, and an outer region located outward from the intermediate region, and
the first coil is disposed in the outer region.

15. The method for fabricating the stator according to claim 13, wherein
a region where the first to third coils are disposed in the coil end is divided into an inner region closest to a center of the stator core, an intermediate region located outward from the inner region, and an outer region located outward from the intermediate region, and
the first coil is disposed in the inner region.

16. The method for fabricating the stator according to claim 13, wherein
a region where the first to third coils are disposed in the coil end is divided into an inner region closest to a center of the stator core, an intermediate region located outward from the inner region, and an outer region located outward from the intermediate region, and
the first coil is disposed in the intermediate region.

17. A method for fabricating a stator, the stator including a stator core and three-phase coils attached to the stator core by distributed winding,
the stator core including 24×n (n is an integer equal to or larger than 1) slots,
the three-phase coils including 8×n U-phase coils, 8×n V-phase coils, and 8×n W-phase coils in a coil end of the three-phase coils and forming 10×n magnetic poles,
the 8×n U-phase coils, the 8×n V-phase coils, and the 8×n W-phase coils each including 2×n sets of coil groups, the 2×n sets of coil groups each including a set of first to fourth coils,
the second coil being disposed inward from the first coil in the coil end,
the second to fourth coils being arranged in that order in a circumferential direction, the method comprising:
disposing the first coil in the stator core at two-slot pitch;
disposing the fourth coil in the stator core at two-slot pitch such that a part of the fourth coil and a part of the third coil are disposed in an identical slot;
disposing the third coil in the stator core at two-slot pitch; and
disposing the second coil at two-slot pitch in the slot where the first coil is disposed such that the first coil and the second coil are disposed with a coil of another phase sandwiched therebetween in the coil end.

18. The method for fabricating the stator according to claim 17, wherein
a region where the first to fourth coils are disposed in the coil end is divided into an inner region closest to a center of the stator core, a first intermediate region located outward from the inner region, a second intermediate region located outward from the first intermediate region, and an outer region located outward from the second intermediate region,
the first coil is disposed in the outer region, and
the second coil is disposed in the inner region.

19. The method for fabricating the stator according to claim 17, wherein
a region where the first to fourth coils are disposed in the coil end is divided into an inner region closest to a center of the stator core, a first intermediate region located outward from the inner region, a second intermediate region located outward from the first intermediate region, and an outer region located outward from the second intermediate region,
the first coil is disposed in the outer region, and
the third coil is disposed in the inner region.

20. The method for fabricating the stator according to claim 17, wherein
a region where the first to fourth coils are disposed in the coil end is divided into an inner region closest to a center of the stator core, a first intermediate region located outward from the inner region, a second intermediate region located outward from the first intermediate region, and an outer region located at an outer side of the second intermediate region,
the second coil is disposed in the inner region, and
the fourth coil is disposed in the outer region.
